(19) United States
(12) Patent Application Publication
(10) Pub. No.: US 2018/0069350 A1
(43) Pub. Date: Mar. 8, 2018

(54) Shield Case and Connector Provided with Same

(71) Applicant: HOSIDEN CORPORATION, Yao-shi, Osaka (JP)

(72) Inventor: Toshiharu Miyoshi, Yao-shi, Osaka (JP)

(21) Appl. No.: 15/573,175

(22) PCT Filed: May 18, 2016
(86) PCT No.: PCT/JP2016/064683

§ 371 Date: Nov. 10, 2017

(30) Foreign Application Priority Data
May 19, 2015 (JP) 2015-102167

(51) Int. Cl. H01R 13/6589; H01R 13/502

(52) U.S. Cl. CPC H01R 13/6589; H01R 2105/00; H01R 13/502

(57) ABSTRACT

A first shell 400 includes a first and a second base 410a, 420a arranged side-by-side, a center plate 430a, a first and a second inner plate 440a, 450a, and a first and a second holding plate 460a, 470a. The center plate 430a is arranged on the Z-direction side relative to the first and second bases 410a, 420a. The first inner plate 440a extends from a first end 411a of the first base 410a to a first end 431a of the center plate 430a. The second inner plate 450a extends from a first end 421a of the second base 420a to a second end 432a of the center plate 430a. The first holding plate 460a is integral and contiguous with a second end 412a of the first base 410a. The second holding plate 470a is integral and contiguous with a second end 422a of the second base 420a.

### BACKGROUND OF THE INVENTION

### Technical Field

The present invention relates to a shield case and a connector having the same.

### Background Art

Patent Literature 1 identified below discloses a conventional first connector. The first connector includes a housing, a shell, terminals, and a plurality of cables. The shell is held by the housing and holds the cables at spaced intervals along a first direction. The first direction is the longitudinal direction of the shell. The shell includes a base and a plurality of holding portions. The base is a rectangular plate extending in the first direction. The holding portions each include a trunk and a holding portion body. The trunks are plates extending in a second direction from an end in the second direction of the base and being arranged at spaced intervals along the first direction. The second direction is the short direction of the shell. The holding portion bodies are plates being provided at distal ends of the trunks and extending in the first direction. The holding portion bodies are curved such as to be wound around the peripheries of the cables. The terminals are held by the housing and connected to the core wires of the cables.

The shell of the first connector is formed by press-forming a single metal plate. In this case, adjacent ones of the holding portions, in planar development state, need be disposed at predetermined intervals along the first direction. This necessity results in increased dimension of the shell in the first direction.

Patent Literature 2 identified below discloses a conventional second connector, which may solve the above problem of the first connector. The second connector has a shell including a base and a plurality of holding portions. The base is a rectangular plate extending in a first direction. The first direction is the longitudinal direction of the shell of the second connector. The holding portions each include a trunk, a first holding piece, and a second holding piece. The trunks are plates extending in a second direction from an end in the second direction of the base and are arranged at spaced intervals along the first direction of the base. The second direction is the short direction of the shell of the second connector. The trunks each include a front portion and a rear portion in the second direction. The first holding pieces extend from the rear portions of the trunks to the one side of the first direction. The second holding pieces extend from the front portions of the trunk to the other side in the first direction. In adjacent ones of holding portions in planar development state, the first holding piece of one of the holding portions and the second holding portion of the other holding portion partially coincide each other in the second direction. Accordingly, the space between the adjacent holding portions is decreased, decreasing the dimension of the shell in the first direction.

### CITATION LIST

### Patent Literatures

Patent Literature 1: JP 2006-294572 A

Patent Literature 2: JP 2006-54101 A

### SUMMARY OF INVENTION

### Technical Problem

However, there is a limit in the decrease of the space in the first direction between the holding portions of the second connector. This is because adjacent holding portions in planar development state must be arranged with a large enough space between the first holding piece of one of the adjacent holding portions and the trunk of the other holding portion so as to allow separation therebetween.

The invention is conceived in view of the above problems, and the invention provides a shield case with a reduced dimension in a first direction in three-dimensional state and with a larger space in the first direction between adjacent holding plates in planar development state. The invention also provides a connector having such shield case.

### Solution to Problem

A shield case of an aspect of the invention includes a first shell constituted by a metal plate. The first shell includes a first base of a plate-like shape, a second base of a plate-like shape, a center plate, a first inner plate, a second inner plate, a first holding plate, and a second holding plate. The first base and the second base are arranged in spaced side-by-side relation along a first direction. The first base comprises a first end at a side of the second base and a second end at one side of a second direction. The second direction crosses the first direction. The second base includes a first end at a side of the first base and a second end at one side of the second direction. The center plate is arranged on one side of a third direction relative to the first and second bases, and the center plate includes a first end on the one side of the first direction and a second end on the other side of the first direction. The third direction crosses the first and second directions. The first inner plate extends to the one side of the third direction, from the first end of the first base to the first end of the center plate. The second inner plate extends to the one side of the third direction, from the first end of the second base to the second end of the center plate. The first holding plate is integral and contiguous with the second end of the first base. The second holding plate is integral and contiguous with the second end of the second base.

The shield case of this aspect has the following technical features. Firstly, the first shell of the shield case in three-dimensional state a decreased dimension in the first direction for the following reasons. The first shell of the shield case in the three-dimensional state is configured such that: the center plate is arranged on the one side of the third direction relative to the first base and the second base; the first inner plate extends to the one side of the third direction, from the first end of the first base to the first end of the center plate; and the second inner plate extends to the one side of the third direction, from the first end of the second base to the second end of the center plate. In this configuration, the space in the first direction between the first base and the second base is narrow, thereby decreasing the dimension in the first direction of the first shell in the three-dimensional state. Secondly, the first shell of the shield case in planar development state has an increased space in the first direction between the first holding plate and the second holding plate. The first shell in planar development state is configured such that the center plate, the first inner plate, the second inner plate, the first base, and the second base are aligned along the first direction. Such alignment results in that the space in the first direction between the first base and the second base increases by the sum of the dimensions in the first direction of the center plate, the first inner plate and the second inner plate. This in turn results in that the space in the first direction substantially increases between the first holding plate, which is integral and contiguous with the first base, and the second holding plate, which is integral and contiguous with the second base. Therefore, it is easy to form the first holding plate and the second holding plate when pressing a single metal plate to form the first shell.

The first shell may further include a first outer plate and a second outer plate. The first outer plate may be formed at the first base and located on the one side of the first direction relative to the first inner plate with a space therebetween. The second outer plate may be formed at the second base and located on the other side of the first direction relative to the second inner plate with a space therebetween. The shield case of this aspect is provided with a first housing space and a second housing space. The first housing space is defined by the first base, the first inner plate, and the first outer plate. The second housing space is defined by the second base, the second inner plate, and the second outer plate.

The shield case of any of the above aspects may further include a block portion having electrical conductivity. The block portion may be arranged in abutment with or in spaced relation to the center plate of the first shell. The block portion may include a first facing portion and a second facing portion. The first facing portion may be arranged in facing relation to and in spaced relation in the third direction to the first base. The second facing portion may be arranged in facing relation to and in spaced relation in the third direction to the second base. The shield case of this aspect is provided with a first housing space and a second housing space. The first housing space is defined by the first base, the first inner plate, and the first facing portion. The second housing space is defined by the second base, the second inner plate, and the first facing portion.

The first shell may further include a first engaging portion. The first engaging portion may be provided at at least one of the first inner plate, the second inner plate, and the center plate. The block portion may further include a second engaging portion. One of the first engaging portion and the second engaging portion may include an engaging protrusion, and the other may include an engaging hole to engage with the engaging protrusion. In the shield case of this aspect, it is easy to engage the block portion with the first shell.

The first shell may further include a third engaging portion. The third engaging portion may be formed on at least one of the first outer plate and the second outer plate. The block portion may further include a fourth engaging portion. The fourth engaging portion may be formed on at least one of the first facing portion and the second facing portion. One of the third engaging portion and the fourth engaging portion may include an engaging protrusion and the other may include an engaging hole to engage with the engaging protrusion. In the shield case of this aspect, it is easy to engage the block portion with the first shell

The shield case of any of the above aspects may further include a second shell having electrical conductivity. The second shell may include a shell body.

The first shell of any of the above aspects may further include a fifth engaging portion provided at at least one of the first base and the second base. The second shell may further include a sixth engaging portion provided at the shell body. One of the fifth engaging portion and the sixth engaging portion comprises an engaging protrusion, and the other comprises an engaging hole to engage with the engaging protrusion. In the shield case of this aspect, it is easy to engage the second shell with the first shell.

The shield case of any of the above aspects may further include a third shell having electrical conductivity. The third shell may include a first plate and a third holding plate. The first plate of the third shell may be arranged between the first base and the second base or between the first inner plate and the second inner plate. The first plate may include an end on one side of the second direction. The third holding plate of the third shell may be provided at the end of the first plate of the third shell and arranged between the first holding plate and the second holding plate. In the shield case of this aspect, the existence of the third shell does not result in increase in dimension in the first direction of the shield case in three-dimensional state for the following reason. The first plate of the third shell is arranged between the first base and the second base or between the first inner plate and the second inner plate, and the third holding plate of the third shell is arranged between the first holding plate and the second holding plate.

The third shell may further include a shell body between the first inner plate and the second inner plate. The shell body of the third shell may include the first plate of the third shell, a second plate and a third plate. The first plate of the shell body may interjoin the second plate and the third plate.

The second plate of the shell body of the third shell may be in abutment with the first inner plate. The third plate of the shell body may be in abutment with the second inner plate. The shield case of this aspect has improved strength. This is because the second plate of the shell body of the third shell abuts the first inner plate, and the third plate of the shell body of the third shell abuts the second inner plate.

The shell body of the third shell may further include a fourth plate. The fourth plate of the third shell may interjoin the second plate and the third plate.

The fourth plate of the third shell may be in abutment with the center plate of the first shell. The shield case of this aspect has further improved strength. This is because the fourth plate of the shell body of the third shell abuts the center plate of the first shell.

The second shell of any of the above aspects may further include a seventh engaging portion provided at the shell body of the second shell. The third shell of any of the above aspects may include an eighth engaging portion. One of the seventh engaging portion and the eighth engaging portion may include an engaging protrusion, and the other may include an engaging hole to engage with the engaging protrusion. In the shield case of this aspect, it is easy to engage the third shell with the second shell.

A connector of a first aspect of the invention may include a first terminal, a second terminal, the shield case of any of the above aspects, a first cable, and a second cable. The first cable may be electrically connected to the first terminal and held by the first holding plate of the first shell. The second cable may be electrically connected to the second terminal and held by the second holding plate of the first shell.

The connector of the first aspect may further include a first body. The first body may hold the first terminal and the second terminal. The connector of this aspect has a decreased number of components. This is because the first terminal and the second terminal are held by a single first body. Alternatively, the connector of the first aspect may further include a first body and a second body. In this case, the first body may hold the first terminal and the second body may hold the second terminal.

The second shell of any of the above aspects may have electrical conductivity and house at least the first body. Alternatively, the second shell of any of the above aspects may have electrical conductivity and house the first body and the second body.

The second shell may be omitted. In this case, preferable configurations are as follows. If the first body holds the first terminal and the second terminal, the first body may include a first holding portion, a second holding portion, and a joint portion. The first holding portion may be arranged on the first base of the first shell to hold the first terminal. The second holding portion may be arranged on the second base of the first shell to hold the second terminal. The joint portion may interjoin the first holding portion and the second holding portion. If the first body holds the first terminal and the second body holds the second terminal, the first body may be arranged on the first base of the first shell, and the second body may be arranged on the second base of the first shell.

The connector of any of the above aspects may further include a third terminal and a third cable. The third cable may be electrically connected to the third terminal and held by the third holding plate of the third shell of any of the above aspects.

The connector of any of the above aspects may further include a third body to hold the third terminal. The joint portion of the first body may include a housing portion. The third body may be housed in the housing portion. If the first body is housed in the second shell, the third body may also be housed in the second shell. The connector of this aspect has a decreased number of components. This is because the first terminal and the second terminal are held by a single first body, and the first body and the third body are housed in a single second shell. Alternatively, if the first holding portion of the first body is arranged on the first base of the first shell and the second holding portion of the first body is arranged on the second base of the first shell, the third body may be arranged on the first plate of the third shell of any of the above aspects.

The second shell of any of the above aspects may include the block portion of any of the above aspects. Also, the shell body of the second shell of any of the above aspects may be arranged on the other side or the one side of the second direction relative to the first shell. The shell body of the second shell may house the first body, may house the first body and the second body, or may house the first body and the third body.

The shield case of any of the above aspects may further include a first cover and a second cover. The first cover may be provided at the block portion to cover the first cable partially. The second cover may be provided at the block portion to cover the second cable partially. The first holding plate may hold the first cover and the first cable. The second holding plate may hold the second cover and the second cable.

The shield case of any of the above aspects may further include a third cover. The third cover may be provided at the block portion of any of the above aspects to cover the third cable partially. Alternatively, the third cover may not be provided at the block portion but at the fourth plate of the third shell of any of the above aspects. In either case, the third holding plate of the third shell of any of the above aspects may hold the third cover and the third cable.

### BRIEF DESCRIPTION OF DRAWINGS

FIG. 1A is a front, top, right side perspective view of a connector of an aspect according to embodiments of the invention.

FIG. 1B is a rear, top, left side perspective view of the connector.

FIG. 2A is a cross-sectional view of the connector taken along line 2A-2A in FIG. 1A.

FIG. 2B is a cross-sectional view of the connector taken along line 2B-2B in FIG. 1A.

FIG. 2C is a cross-sectional view of the connector taken along line 2C-2C in FIG. 1A.

FIG. 2D is a cross-sectional view of the connector taken along line 2D-2D in FIG. 1A.

FIG. 2E is a cross-sectional view of the connector taken along line 2E-2E in FIG. 1A.

FIG. 2F is a cross-sectional view of the connector taken along line 2F-2F in FIG. 1A.

FIG. 2G is a cross-sectional view of the connector taken along line 2G-2G in FIG. 1A.

FIG. 2H is a cross-sectional view of the connector taken along line 2H-2H in FIG. 1A.

FIG. 3A is a front, top, right side perspective view of a first unit, a second unit, and a cap of the connector.

FIG. 3B is a rear, bottom, left side perspective view of the first unit, the second unit, and a cap of the connector.

FIG. 4A is a front, top, right side exploded perspective view of the first unit and the second unit of the connector.

FIG. 4B is a rear, bottom, left side exploded perspective view of the first unit and the second unit of the connector.

FIG. 5 is a developed view of a first shell of the first unit of the connector.

FIG. 6A is a front, top, right side exploded perspective view of the second unit.

FIG. 6B is a rear, bottom, right side exploded perspective view of the second unit.

### DESCRIPTION OF EMBODIMENTS

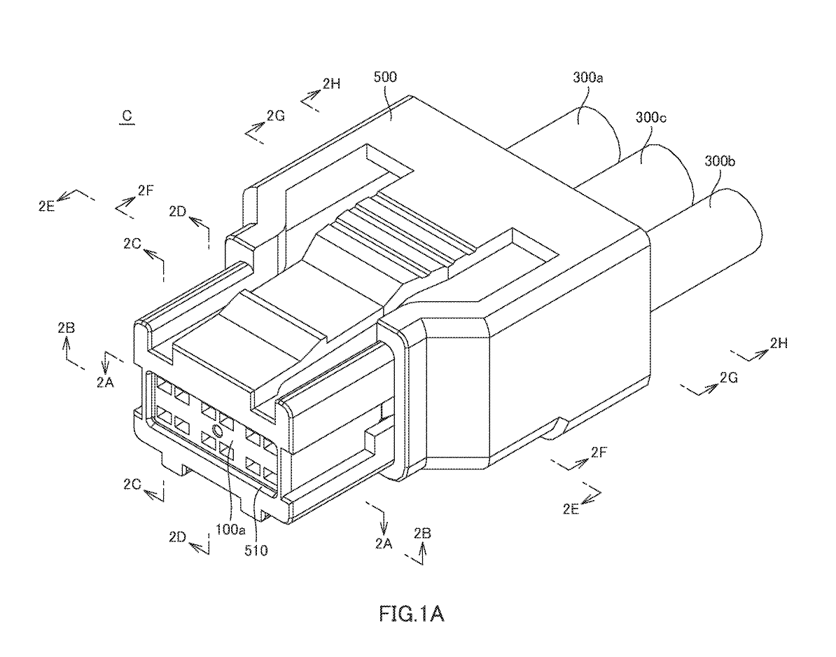

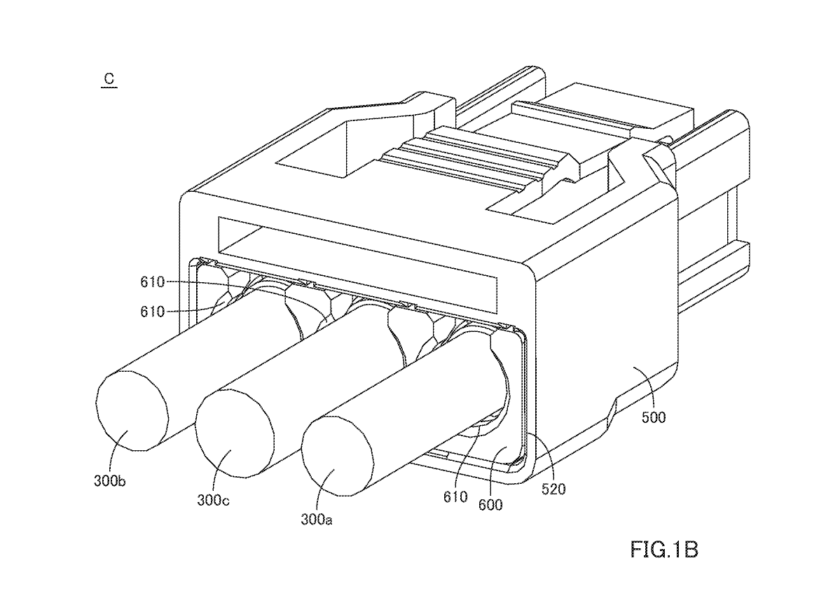

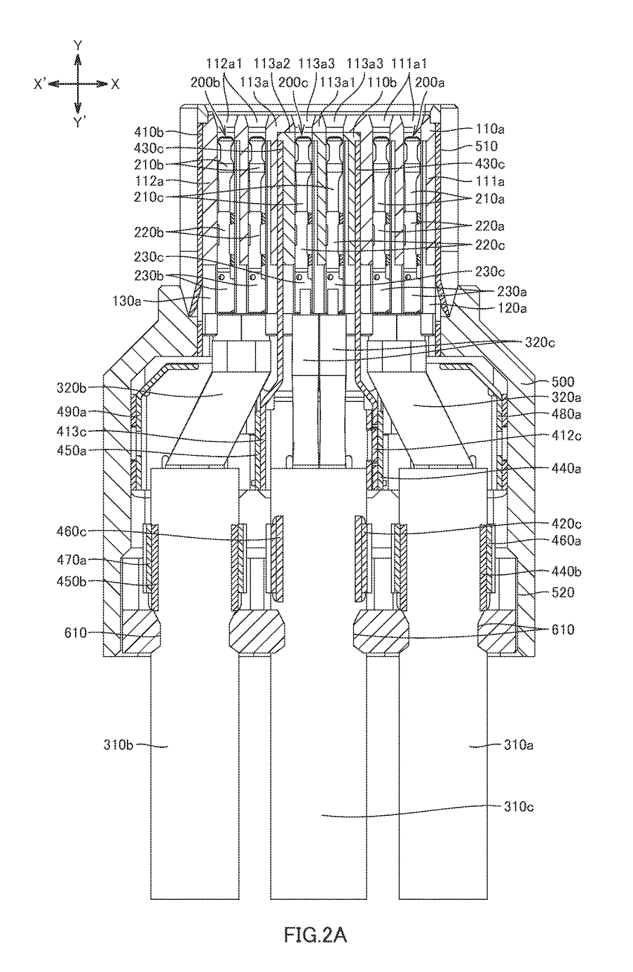

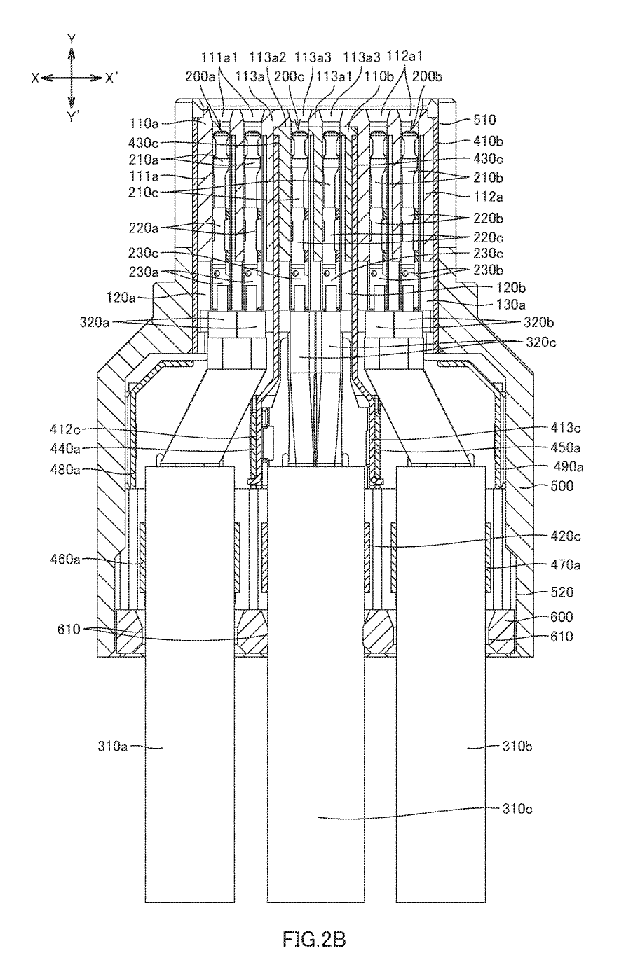

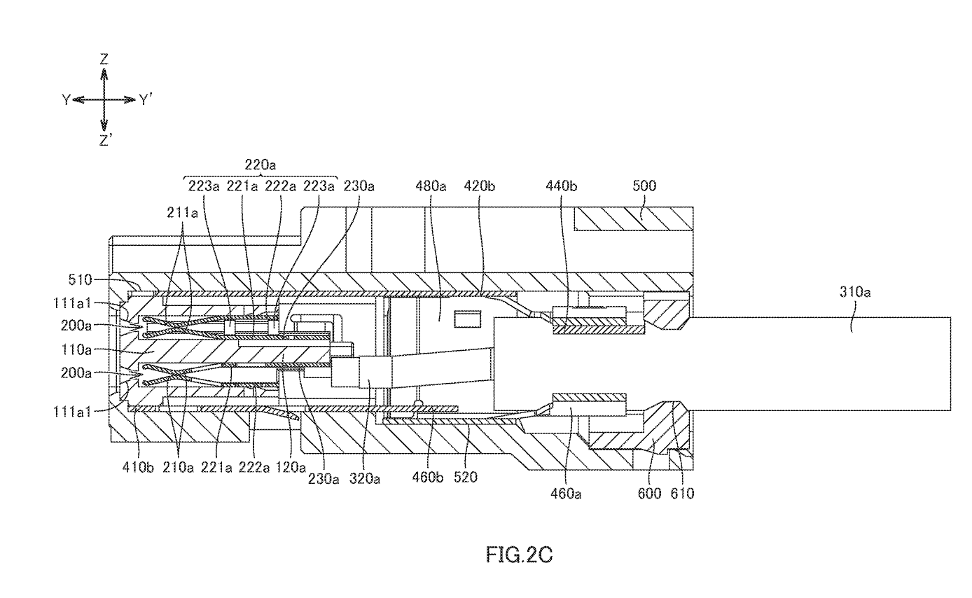

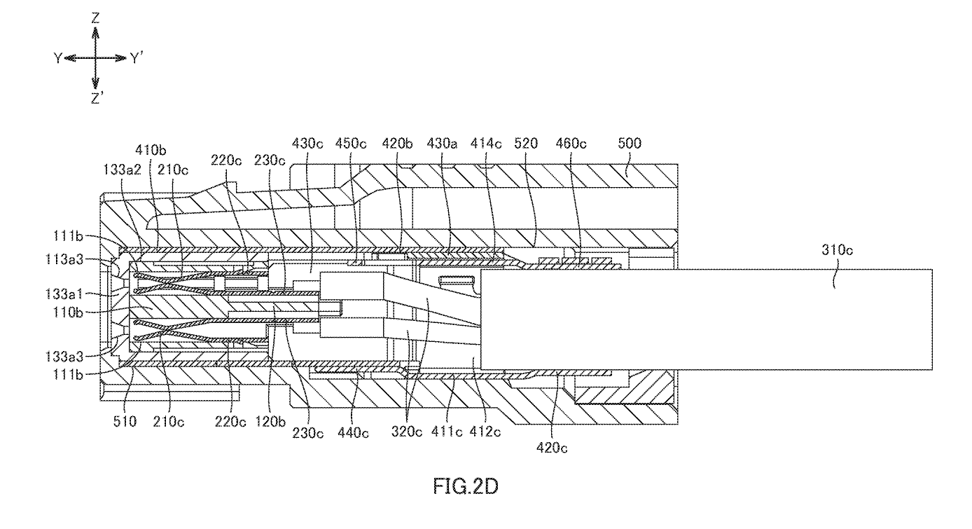

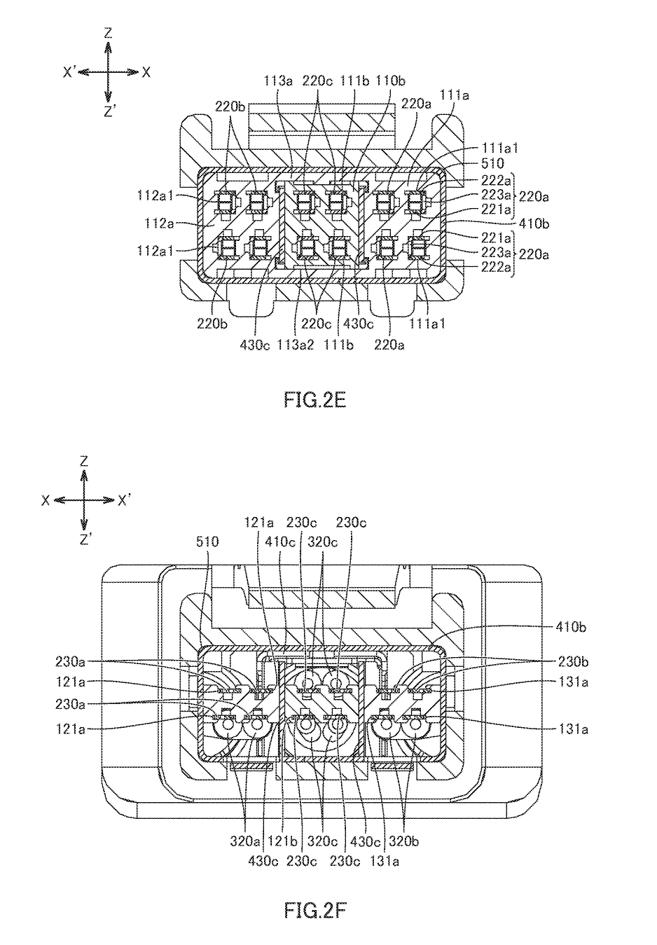

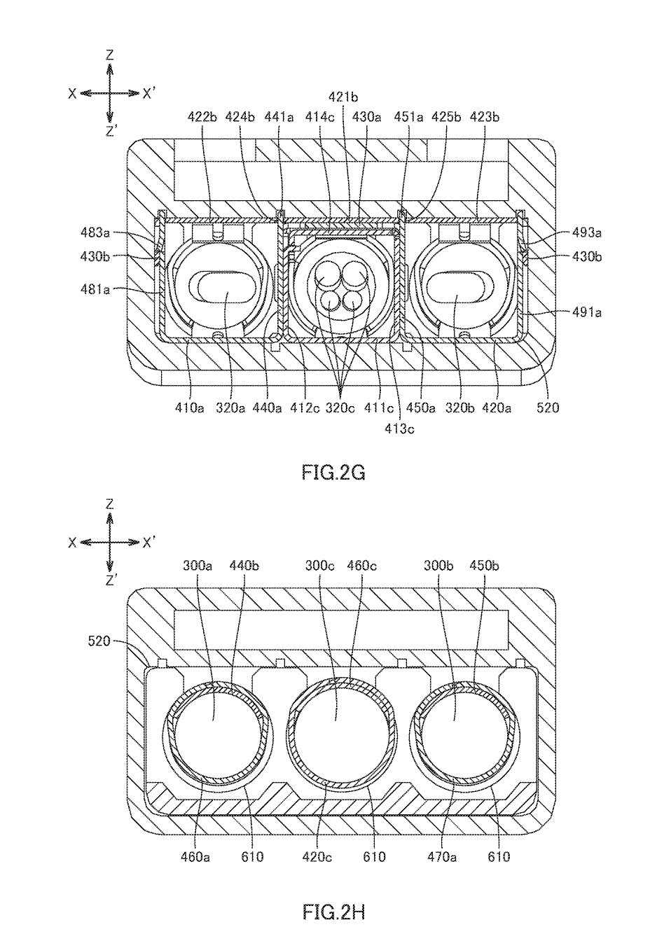

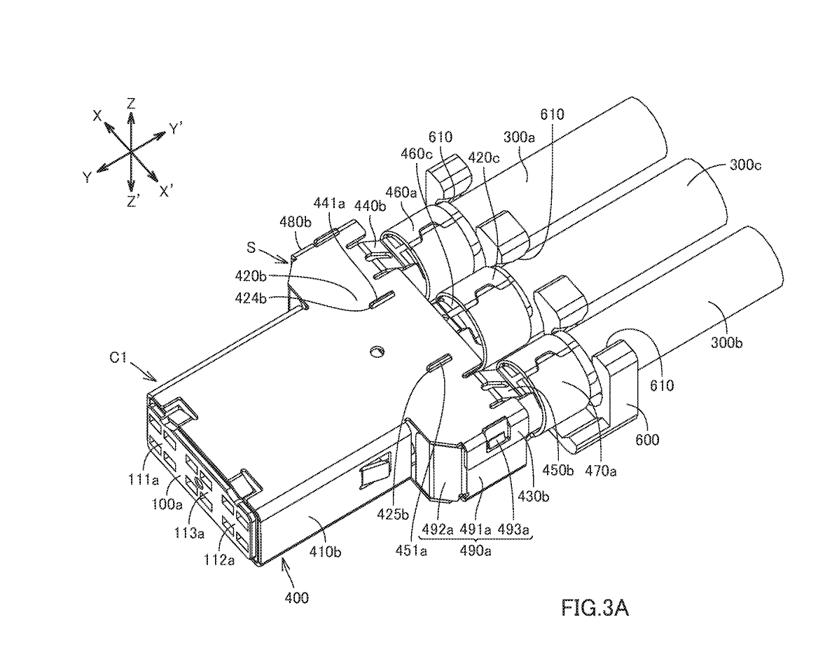

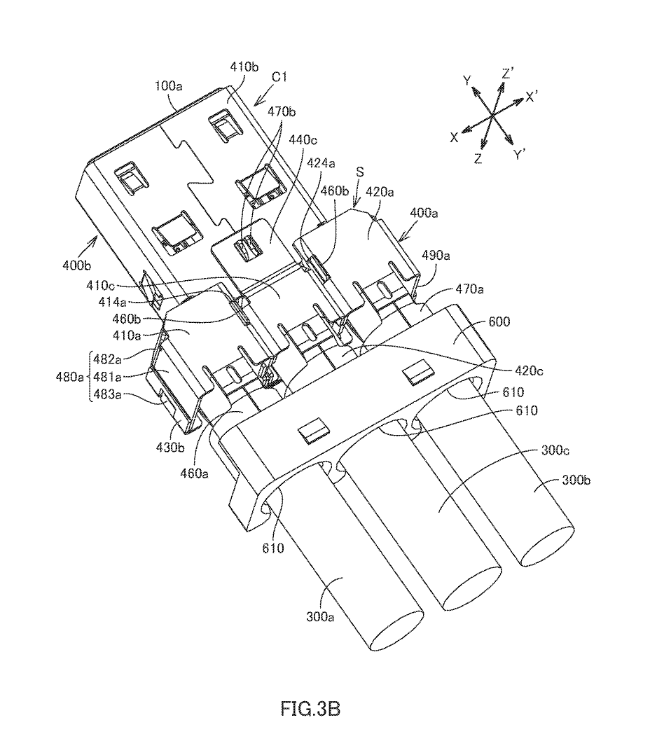

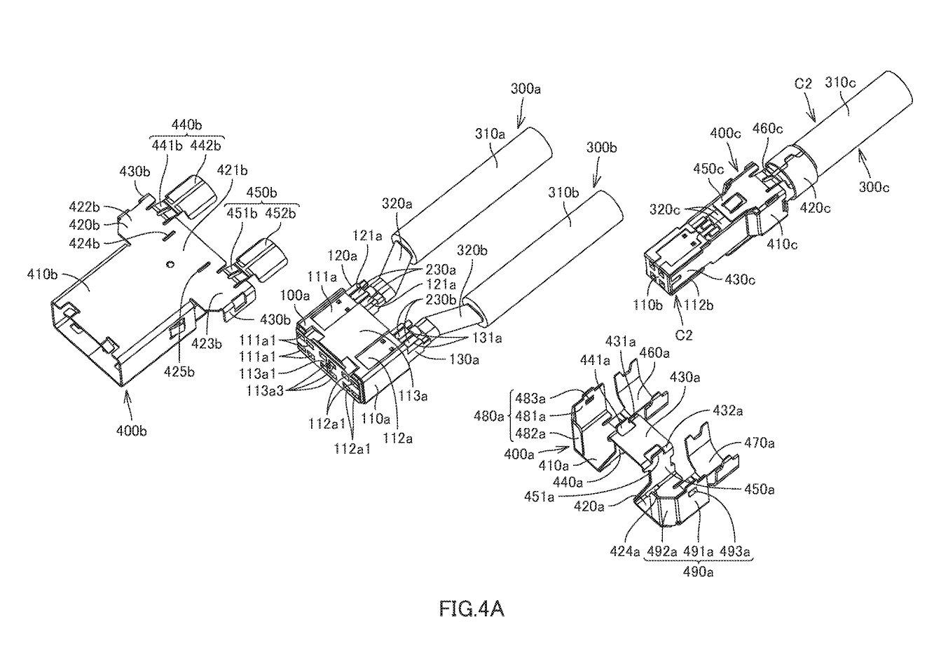

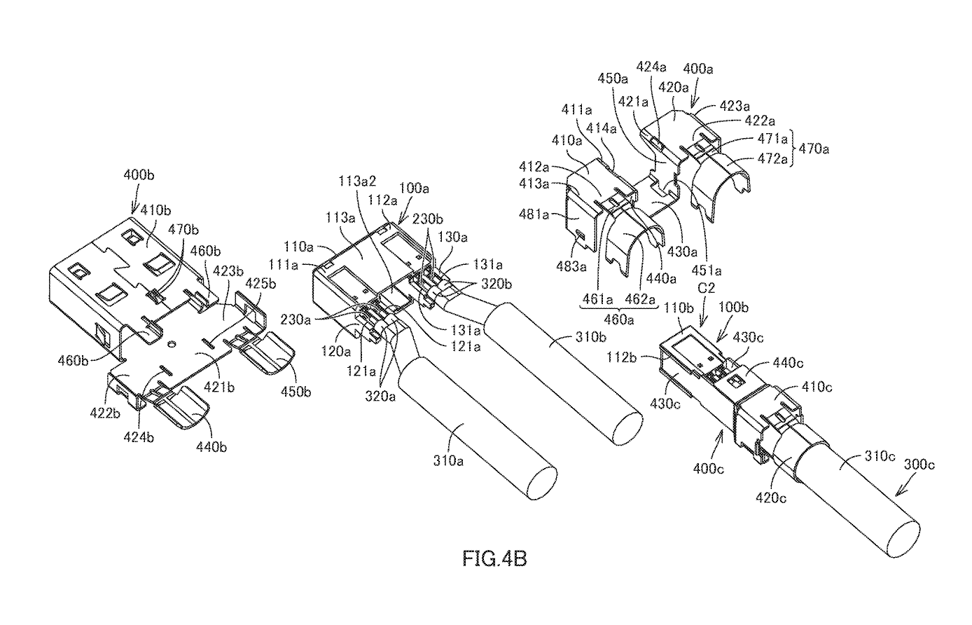

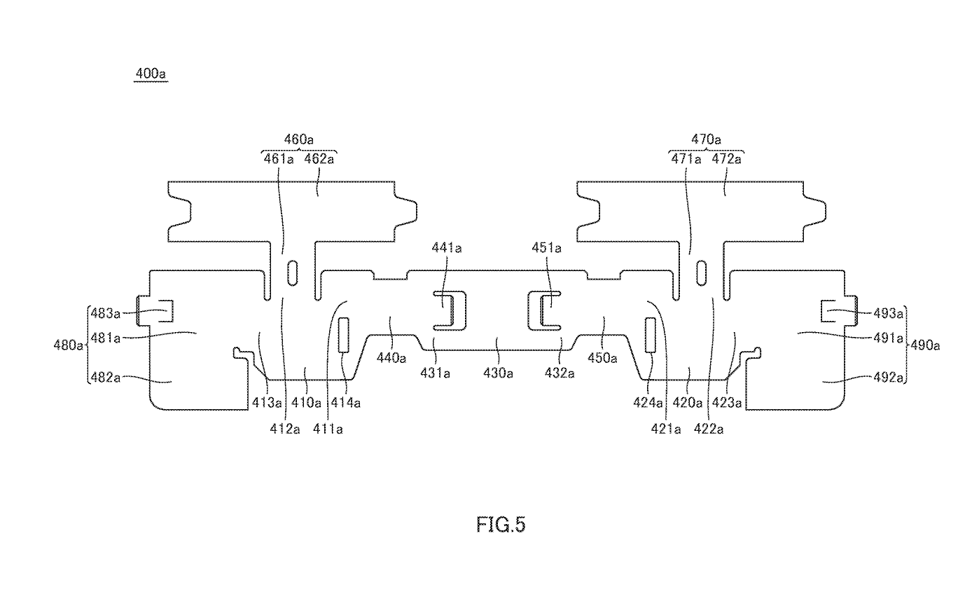

A connector C according to embodiments of the invention will be hereinafter described with reference to FIGS. 1A to 6B. The connector C includes a first unit C1 (see FIGS. 3A and 3B), and a second unit C2 (see FIGS. 4A and 4B). Components of the connector C will be hereinafter described in detail. Here, the X-X′ direction shown in FIGS. 2A, 2B, 2E to 2H, and 3A to 4B is the short direction of the connector C and corresponds to the first direction in the claims. In the X-X′ direction, the X direction corresponds to one side of the first direction, and the X′ direction corresponds to the other side of the first direction. The Y-Y′ direction shown in FIGS. 2C to 4B is the longitudinal direction of the connector C and corresponds to the second direction in the claims. The Y-Y′ direction is orthogonal to the X-X′ direction. In the Y-Y′ direction, the Y′ direction corresponds to one side of the second direction, and the Y direction corresponds to the other side of the second direction. The Z-Z′ direction shown in FIGS. 2A, 2B, 2E to 2H, and 3A to 4B is the height direction of the connector C and corresponds to the third direction in the claims. In the Z-Z′ direction, the Z direction corresponds to one side of the third direction, and the Z′ direction corresponds to the other side of the third direction. The Z-Z″ direction is orthogonal to the X-X′ and Y-Y′ directions.

The first unit C1 includes a body 100a (first body), at least one first terminal 200a, at least one second terminal 200b, a first cable 300a, a second cable 300b, a first shell 400a, and a second shell 400b. The second unit C2 includes a body 100b (third body), at least one third terminal 200c, a third cable 300c, and a third shell 400c. It should be appreciated that the first shell 400a, the second shell 400b, and the third shell 400c constitute a shield case S of the connector C. Also, a plurality of the first terminals 200a, a plurality of the second terminals 200b, and a plurality of the third terminals 200c may be provided.

The first and second terminals 200a and 200b are each constituted by a metal plate. The first and second terminals 200a and 200b are held by the body 100a. Each first terminal 200a includes a contact portion 210a, an intermediate portion 220a, and a tail 230a. The intermediate portion 220a may only interjoin the contact portion 210a and the tail portion 230a and be adapted to be held by the body 100a. For example, as best illustrated in FIGS. 2C and 2E, the intermediate portion 220a includes a first plate 221a, a second plate 222a, and at least one joint plate 223a. The first plate 221a and the second plate 222a extend in the Y-Y′ direction and face each other in the Z-Z′ direction. The joint plate 223a interjoins the first plate 221a and the second plate 222a.

Each contact portion 210a may only be contactable with a corresponding terminal of a mating connector. For example, the contact portion 210a may include a pair of arms 211a facing each other in Z-Z′ direction. One of the arms 211a extends from the first plate 221a in the Y direction and the other arm 211a extends from the second plate 222a in the Y direction. Distal end portions of the arms 211a are bent such as to approach each other. The tail 230a may only extend from the intermediate portion 220a in the Y′ direction. For example, the tail 230a may extend from the first plate 221a of the intermediate portion 220a in the Y′ direction.

The second terminal 220b will not be described because it has a similar configuration to that of the first terminal 200a. Each second terminal 200b includes a contact portion 210b, an intermediate portion 220b, and a tail 230b.

The body 100a, best illustrated in FIG. 4A and FIG. 4B, is constituted by insulation resin. The body 100a includes a main body 110a. The main body 110a is a rectangular block. The main body 110a includes a first holding portion 111a, a second holding portion 112a, and a joint portion 113a.

The first holding portion 111a holds the at least one first terminal 200a of the main body 110a. For example, as best illustrated in FIG. 4A and FIG. 4B, the first holding portion 111a may be an X-direction-side end portion of the main body 110a. The first holding portion 111a may be provided with at least one holding hole 111a1 to hold the first terminal 200a. For example, the first holding portion 111a may be provided with a plurality of holding holes 111a1 arranged in two rows in the Z-Z′ direction, at spaced intervals along X-X′ direction. As best illustrated in FIG. 2C, each holding hole 111a1 extends through the first holding portion 111a in the Y-Y′ direction. Each holding hole 111a1 has a shape conforming to the outer shapes of the intermediate portion 220a and the contact portion 210a of the corresponding first terminal 200a. Each holding hole 111a1 holds the intermediate portion 220a of a first terminal 200a and houses the contact portion 210a of the first terminal 200a. Alternatively, the at least one first terminal 200a may be insert-molded in the first holding portion 111a. In this case, the holding hole 111a1 is omitted.

The second holding portion 112a holds the at least one second terminal 200b of the main body 110a. For example, as best illustrated in FIG. 4A and FIG. 4B, the second holding portion 112a may be an X′-direction side end portion of the main body 110a. The second holding portion 112a may be provided with at least one holding hole 112a1 to hold the second terminal 200b. For example, the second holding portion 112a may be provided with a plurality of holding holes 112a1 arranged in two rows in the Z-Z′ direction, at spaced intervals along X-X′ direction. Each holding hole 112a1 has a similar configuration to that of the holding hole 111a1 and extends through the second holding portion 112a in the Y-Y′ direction (see FIG. 2C showing a similar configuration). Each holding hole 112a1 holds the intermediate portion 220b of a second terminal 200b and houses the contact portion 210b of the second terminal 200b. Alternatively, the at least one second terminal 200b may be insert-molded in the second holding portion 112a. In this case, the holding hole 112a1 is omitted.

The joint portion 113a may only interjoin the first holding portion 111a and the second holding portion 112a. For example, the joint portion 113a may be a part of the main body 110a located between the first holding portion 111a and the second holding portion 112a. The joint portion 113a may include a front panel 113a1 and a housing portion 113a2. The housing portion 113a2 is a rectangular hole in the joint portion 113a and extends in the Y-Y″ direction. The housing portion 113a2 is open to the Y′-direction side. The front panel 113a1 is disposed such as to block the Y-direction side of the housing portion 113a2. The front panel 113a1 is provided with at least one opening 113a3. Each opening 113a3 communicates with a housing portion 113a2. For example, the front panel 113a1 is provided with a plurality of openings 113a3 arranged in two rows in the Z-Z′ direction, at spaced intervals along the X-X′ direction. Also, each housing portion 113a2 may be a space between the first holding portion 111a and the second holding portion 112a joined by the joint portion 113a.

As best illustrated in FIG. 4A and FIG. 4B, the body 100a may further include a first table 120a and a second table 130a. The first table 120a extends in the Y′ direction from the Y′-direction-side end face of the first holding portion 111a. The first table 120a may only be able to support the tail 230a of the at least one first terminal 200a. The first table 120a may include at least one holding groove 121a. Each holding groove 121a is provided in the first table 120a such as to communicate with a holding hole 111a1 of the first holding portion 111a. Each holding groove 121a houses and supports a tail 230a. For example, as best illustrated in FIG. 2F, a plurality of holding grooves 121a may be provided in the Z-direction-side face of the first table 120a, at spaced intervals along the X-X′ direction, and another plurality of holding grooves 121a may be provided in the Z′-direction-side face of the first table 120a, at spaced intervals along the X-X′ direction.

The second table 130a extends in the Y′ direction from the Y′-direction-side end face of the second holding portion 112a. The second table 130a may only be able to support the tail 230b of the at least one second terminal 200b. The second table 130a may include at least one holding groove 131a. Each holding groove 131a is provided in the second table 130a such as to communicate with a holding hole 112a1 of the second holding portion 112a. The holding groove 131a houses and supports the tail 230b. For example, as best illustrated in FIG. 2F, a plurality of holding grooves 131a may provided in the Z-direction-side surface of the second table 130a, at spaced intervals along the X-X′ direction, and another plurality of holding grooves 131a may be provided in the Z′-direction-side surface of the second table 130a, at spaced intervals along the X-X′ direction.

The first shell 400a is arranged on the Y′-direction side relative to the body 100a. The first shell 400a is formed by press-forming a single metal plate. A three-dimensional state of the first shell 400a is best illustrated in FIGS. 4A and 4B, and a planar development state of the first shell 400a is best illustrated in FIG. 5. The first shell 400a includes a first base 410a, a second base 420a, a center plate 430a, a first inner plate 440a, a second inner plate 450a, a first holding plate 460a, and a second holding plate 470a. The center plate 430a is a central part of the metal plate mentioned above (a part of the metal plate). The center plate 430a extends in the X-X′ and Y-Y′ directions. The center plate 430a is arranged on the Z-direction side relative to the first base 410a and the second base 420a. For example, the center plate 430a may be arranged on the Z-direction side relative to, and between, the first base 410a and the second base 420a. The center plate 430a includes a first end 431a and a second end 432a. The first end 431a is the X-direction-side end of the center plate 430a. The second end 432a is the X′-direction-side end of the center plate 430a.

The first base 410a is a part of the metal plate on the X-direction side relative to the center plate 430a (i.e. the first base 410a has a plate-like shape). The first base 410a extends in the X-X′ and Y-Y′ directions. The second base 420a is a part of the metal plate on the X′-direction side relative to the center plate 430a (i.e. the second base 420a has a plate-like shape). The second base 420a extends in the X-X′ and Y-Y′ directions. The first base 410a and the second base 420a are arranged side-by-side along the X-X′ direction. The first base 410a and the second base 420a may be arranged at the same height position, or at different height positions, in the Z-Z′ direction.

The first base 410a includes a first end 411a, a second end 412a, and a third end 413a. The first end 411a is the X′-direction-side end of the first base 410a (the end at the side of the second base 420a). The second end 412a is the Y′-direction-side end of the first base 410a. The second end 412a may have a central part recessed in the Y direction or may be flat. The third end 413a is the X-direction-side end of the first base 410a. The second base 420a includes a first end 421a, a second end 422a, and a third end 423a. The first end 421a is the X-direction-side end of the second base 420a (the end at the side of the first base 410a). The second end 422a is the Y′-direction-side end of the second base 420a. The second end 422a may have a central part recessed in the Y direction or may be flat. The third end 423a is the X′-direction-side end of the second base 420a.

The first inner plate 440a is a part between the center plate 430a and the first base 410a of the metal plate. The first inner plate 440a extends in the Z direction, from the first end 411a of the first base 410a to the first end 431a of the center plate 430a. The first inner plate 440a may be inclined in the X direction, the X′ direction, the Y direction, the Y′ direction, a direction including X- and Y-direction components, a direction including a X′- and Y-direction components, a direction including a X- and a Y′-direction components, or a direction including a X′- and a Y′-direction components. Off course, the first inner plate 440a may not be inclined, i.e. may extend at an angle of about 90 degrees to the first base 410a.

The second inner plate 450a is a part between the center plate 430a and the second base 420a of the metal plate. The second inner plate 450a extends in the Z direction, from the first end 421a of the second base 420a to the second end 432a of the center plate 430a. The second inner plate 450a may be inclined in the X direction, the X′ direction, the Y direction, the Y′ direction, a direction including X- and Y-direction components, a direction including a X′- and Y-direction components, a direction including a X- and a Y′-direction components, or a direction including a X′- and a Y′-direction components. Off course, the second inner plate 450a may not be inclined, i.e. may extend at an angle of about 90 degrees to the second base 420a.

The first holding plate 460a is a part at the Y′-direction side of the first base 410a of the metal plate. The first holding plate 460a is integral and contiguous with the second end 412a of the first base 410a. The first holding plate 460a includes a trunk 461a and a holding plate body 462a. The trunk 461a is a plate extending in the Y′ direction from the second end 412a of the first base 410a. The holding plate body 462a is a plate integral and contiguous with the Y′-direction-side end of the trunk 461a. In planar development state, the holding plate body 462a is larger in X-X′ direction dimension than the trunk 461a.

The second holding plate 470a is a part at the Y′-direction side of the second base 420a of the metal plate. The second holding plate 470a is integral and contiguous with the second end 422a of the second base 420a. The second holding plate 470a includes a trunk 471a and a holding plate body 472a. The trunk 471a is a plate extending in the Y′ direction from the second end 422a of the second base 420a. The holding plate body 472a is a plate integral and contiguous with the Y′-direction-side end of the trunk 471a. In planar development state, the holding plate body 472a is larger in X-X′ direction dimension than the trunk 471a.

The first shell 400a may further include a first outer plate 480a and a second outer plate 490a. The first outer plate 480a may only be provided at the first base 410a such as to be on the X-direction side relative to the first inner plate 450a with a space therebetween. For example, the first outer plate 480a may be a part on the X-direction side of the first base 410a of the metal plate and extend in the Z direction from the third end 413a of the first base 410a. The first outer plate 480a may be a piece formed by cutting and raising a part of the first base 410a, or may be a member separately formed from the first base 410a to be fixed to the first base 410a. The first outer plate 480a may be inclined in the X direction, the X′ direction, the Y direction, the Y′ direction, a direction including X- and Y-direction components, a direction including a X′- and Y-direction components, a direction including a X- and a Y′-direction components, or a direction including a X′- and a Y′-direction components. Off course, the first outer plate 480a may not be inclined, i.e. may extend at an angle of about 90 degrees to the first base 410a. The first outer plate 480a, the first base 410a, and the first inner plate 440a may define a first housing space.

The first outer plate 480a may include an outer plate body 481a and an extension plate 482a. The outer plate body 481a extends in the Z direction from the third end 413a of the first base 410a. The outer plate body 481a includes a Y-direction-side end.

The extension plate 482a is integral and contiguous with the Y-direction-side end of the outer plate body 481a. The extension plate 482a is bent to the X′-direction side relative to the outer plate body 481a so as to partially cover the Y-direction side of the first housing space. A first gap is left between the extension plate 482a and the first inner plate 440a.

The second outer plate 490a may only be provided at the second base 420a such as to be on the X-direction side relative to the second inner plate 460a with a space therebetween. For example, the second outer plate 490a may be a part on the X′-direction side of the second base 420a of the metal plate and extend in the Z direction from the third end 423a of the second base 420a. The second outer plate 490a may be a piece formed by cutting and raising a part of the second base 420a, or may be a member separately formed from the second base 420a to be fixed to the second base 420a. The second outer plate 490a may be inclined in the X direction, the X′ direction, the Y direction, the Y′ direction, a direction including X- and Y-direction components, a direction including a X′- and Y-direction components, a direction including a X- and a Y′-direction components, or a direction including a X′- and a Y′-direction components. Off course, the second outer plate 490a may not be inclined, i.e. may extend at an angle of about 90 degrees to the second base 420a. The second outer plate 490a, the second base 420a, and the second inner plate 450a may define a second housing space.

The second outer plate 490a may include an outer plate body 491a and an extension plate 492a. The outer plate body 491a extends in the Z direction from the third end 423a of the second base 420a. The outer plate body 491a includes a Y-direction-side end.

The extension plate 492a is integral and contiguous with the Y-direction-side end of the outer plate body 491a. The extension plate 492a is bent to the X-direction side relative to the outer plate body 491a so as to partially cover the Y-direction side of the second housing space. A second gap is left between the extension plate 492a and the second inner plate 450a.

The first cable 300a includes an outer insulator 310a, a shield conductor (not shown), and at least one transmission wire 320a. The outer insulator 310a is a tuboid sheath. The shield conductor, tuboid braided conductive wires or a helically wound metal foil tape, is arranged inside the outer insulator 310a. The transmission wire(s) 320a is arranged inside the shield conductor. The Y-direction-side end portion of the outer insulator 310a is cut off such as to expose the Y-direction-side end portion end portion of the shield conductor. Around the exposed shield conductor is wound the holding plate body 462a of the first holding plate 460a for electrically connection therebetween (see FIGS. 2A to 2C, 2H, 3A, and 3B). The Y-direction-side end portion of the transmission wire 320a protrudes in the Y direction from the shield conductor. The protruding portion of each transmission wire 320a (hereinafter referred to as the protruding portion) is cut off at its distal end such as to expose the core wire inside the transmission wire 320a. The protruding portion of each transmission wire 320a passes through the first housing space and the first gap, and the core wire of each transmission wire 320a is electrically connected to the tail 230a of a first terminal 200a. For example, there may be two transmission wires 320a, the core wires of which may be connected to the respective tails 230a of two first terminals 200a on the Z′ direction side. It should be noted that FIGS. 2A to 2C, 2G, and 2H show only the outline of the section of the first cable 300a. FIGS. 4A and 4B show the holding plate body 462a before being wound around the shield conductor.

The second cable 300b has a similar configuration to that of the first cable 300a. The second cable 300b includes an outer insulator 310b, a shield conductor (not shown), and at least one transmission wire 320b. The holding plate body 472a of the second holding plate 470a is wound around and electrically connected to the exposed portion of the shield conductor (see FIGS. 2A, 2B, 2H, 3A, and 3B). The protruding portion of each transmission wire 320b passes through the second housing space and the second gap, and the core wire of each transmission wire 320b is electrically connected to the tail 230b of a second terminal 200b. For example, there may be two transmission wires 320b, the core wires of which may be connected to the tails 230b of two second terminals 200b on the Z′ direction side. It should be noted that FIGS. 2A, 2B, 2G, and 2H show only the outline of the section of the second cable 300b. FIGS. 4A and 4B show the holding plate body 472a before being wound around the shield conductor.

As best illustrated in FIGS. 4A and 4B, the second shell 400b is formed by press-forming a single metal plate. The second shell 400b includes a shell body 410b and a block portion 420b. The shell body 410b is a tube extending in the Y-Y′ direction and arranged on the Y-direction side relative to the first shell 400a. The shell body 410b has an inner shape conforming to the outer shape of the body 100a. The shell body 410b houses the body 100a. The shell body 410b includes a first plate on the Z′-direction side, a second plate on the X-direction side, a third plate on the X′-direction side and a fourth plate on the Z-direction side. The first plate includes an X-direction-side end and an X′-direction-side end. The fourth plate includes an X-direction-side end and an X′-direction-side end. The second plate integrally interjoins the X-direction-side end of the first plate and the X-direction-side end of the fourth plate. The third plate integrally interjoins the X′-direction-side end of the first plate and the X′-direction-side end of the fourth plate.

The block portion 420b is a plate extending in the Y′ direction from the fourth plate of the shell body 410b. The block portion 420b is arranged in abutment with the center plate 430a of the first shell 400a from the Z-direction side or in spaced relation in the Z-Z′ direction to the center plate 430a. The block portion 420b blocks the first housing space and the second housing space of the first shell 400a from the Y-direction side. The block portion 420b may include a center portion 421b, a first facing portion 422b, and a second facing portion 423b. As best illustrated in FIG. 2G, the center portion 421b is in abutment (in surface contact) with the center plate 430a from the Z-direction side. The first facing portion 422b is in facing relation to and in spaced relation in the Z-Z′ direction to the first base 410a of the first shell 400a and blocks the first housing space from the Z-direction side. The first facing portion 422b may be in abutment with the first outer plate 480a of the first shell 400a. If the first outer plate 480a is omitted, the first housing space may preferably be defined by the first base 410a, the first inner plate 440a, and the first facing portion 422b. The second facing portion 423b is in facing relation to and in spaced relation in the Z-Z′ direction to the second base 420a of the first shell 400a and blocks the second housing space from the Z-direction side. The second facing portion 423b may be in abutment with the second outer plate 490a of the first shell 400a. If the second outer plate 490a is omitted, the second housing space may preferably be defined by the second base 420a, the second inner plate 450a, and the second facing portion 423b. The first facing portion 422b includes an X-direction-side end and an Y′-direction-side end. The second facing portion 423b includes an X′-direction-side end and an Y′-direction-side end.

At least one of the first inner plate 440a, the second inner plate 450a, and the center plate 430a of the first shell 400a may be provided with a first engaging portion. The block portion 420b of the second shell 400b may be provided with a second engaging portion. One of the first engaging portion and the second engaging portion may include an engaging protrusion, and the other may have an engaging hole to engage with the engaging protrusion.

For example, as best illustrated in FIG. 2G and FIG. 4A, the first inner plate 440a may include a first engaging portion 441a, and the second inner plate 450a may include another first engaging portion 451a. The first engaging portion 441a includes an engaging protrusion of a plate-like shape, which is formed by cutting and bending a part of the center plate 430a such that the cut part extends in the Z direction from the first inner plate 440a. The first engaging portion 451a includes an engaging protrusion of a plate-like shape, which is formed by cutting and bending another part of the center plate 430a such that the cut part extends in the Z direction from the second inner plate 450a. In this case, the block portion 420b includes second engaging portions 424b, 425b. The second engaging portion 424b has an engaging hole at a position corresponding to the first engaging portion 441a of the block portion 420b. The second engaging portion 425b has an engaging hole at a position corresponding to the first engaging portion 451a of the block portion 420b. The first engaging portion 441a is engaged with the second engaging portion 424b from the Z′-direction side, and the first engaging portion 451a is engaged with the second engaging portion 425b from the Z′-direction side.

Further, if the center plate 430a includes at least one first engaging portion, the first engaging portion may include an engaging protrusion of a plate-like shape, which is formed by cutting and bending a part of at least one of the center plate 430a, the first inner plate 440a, and the second inner plate 450a such that the cut part extends in the Z direction from the center plate 430a. In this case, at least one second engaging portion may include an engaging hole to engage with the first engaging portion, at a position corresponding to the first engaging portion of the center plate 430a of the block portion 420b. Alternatively, the at least one second engaging portion may include an engaging protrusion of a plate-like shape, which is formed by cutting and bending a part of the block portion 420b such that the cut part extends in the Z′ direction from the block portion 420b. In this case, the at least one first engaging portion may have an engaging hole to engage with the second engaging portion of the block portion 420b, in at least one of the first inner plate 440a, the second inner plate 450a, and the center plate 430a.

At least one of the first outer plate 480a and the second outer plate 490a of the first shell 400a may be provided with a third engaging portion. At least one of the first facing portion 422b and the second facing portion 423b of the block portion 420b of the second shell 400b may be provided with a fourth engaging portion. One of the third engaging portion and the fourth engaging portion may include may include an engaging protrusion, and the other may include an engaging hole to engage with the engaging protrusion.

For example, as best illustrated in FIG. 2G and FIG. 4A, the first outer plate 480a may include a third engaging portion 483a, and the second outer plate 490a may include a third engaging portion 493a. The third engaging portion 483a includes an engaging protrusion of a plate-like shape, which is formed by cutting a part of the outer plate body 481a and bending the cut part to the X direction. The third engaging portion 493a includes an engaging portion of a plate-like shape, which is formed by cutting a part of the outer plate body 491a and bending the cut part in the X′ direction. In this case, the block portion 420b includes a pair of fourth engaging portions 430b (one and the other fourth engaging portions 430b). The one fourth engaging portion 430b includes an engaging piece, which extends in the Z′ direction from the X-direction-side end of the first facing portion 422b, and an engaging hole formed in the engaging piece. The other fourth engaging portion 430b includes an engaging piece, which extends in the Z′ direction from X′-direction-side end of the second facing portion 423b, and an engaging hole formed in the engaging piece. The third engaging portion 483a and the third engaging portion 493a are engaged with the respective engaging holes of the fourth engaging portions 430b.

The pair of fourth engaging portions may include engaging protrusions in place of the engaging holes. The engaging protrusion of each fourth engaging portion may be a plate formed by cutting and bending a part of an engaging piece. In this case, the third engaging portion of the first outer plate 480a may have an engaging hole to engage with the engaging protrusion of the one fourth engaging portion. The third engaging portion of the second outer plate 490a may have an engaging hole to engage with the engaging protrusion of the other fourth engaging portion.

At least one of the first base 410a and the second base 420a of the first shell 400a may be provided with a fifth engaging portion. The shell body 410b of the second shell 400b may be provided with a sixth engaging portion. One of the fifth engaging portion and the sixth engaging portion may include an engaging protrusion, and the other may include an engaging hole to engage with the engaging protrusion.

For example, as best illustrated in FIG. 3B and FIG. 4B, the second shell 400b may include a pair of sixth engaging portions 460b. Each sixth engaging portion 460b includes an arm, which extends in the Y′ direction from the first plate of the shell body 410b, and an engaging protrusion provided at the arm. In this case, the first shell 400a includes a fifth engaging portion 414a and a fifth engaging portion 424a. The fifth engaging portion 414a includes an engaging hole in the first base 410a. The fifth engaging portion 424a includes an engaging hole in the second base 420a. The engaging holes of the fifth engaging portion 414a and the fifth engaging portion 424a are engaged with the respective engaging protrusions of the sixth engaging portions 460b.

Further, the sixth engaging portion may include an engaging hole instead of the engaging protrusion. The engaging hole of each sixth engaging portion may be provided at the arm or at the first plate of the shell body 410b. In the latter case, the arm is omitted. In these cases, each fifth engaging portion may include engaging protrusions of a plate-like shape, which is formed by cutting and bending parts of the first base 410a and the second base 420a. The engaging protrusions of the fifth engaging portions are engaged with the respective engaging holes of the sixth engaging portions.

The second shell 400b may further include at least one of a first cover 440b and a second cover 450b. The first cover 440b is provided at the first facing portion 422b of the block portion 420b of the second shell 400b. The first cover 440b includes a base 441b and a cover body 442b. The base 441b is a plate extending in the Y′ direction from the Y′-direction-side end of the first facing portion 422b. The cover body 442b is a plate of an arc shape that is integral and contiguous with the Y′-direction-side end of the base 441b. The cover body 442b partially covers the exposed shield conductor of the first cable 300a. If the second shell 400b includes the first cover 440b, the first holding plate 460a of the first shell 400a is curved so as to be wound around the cover body 442b and the exposed shield conductor of the first cable 300a as best illustrated in FIG. 2H.

The second cover 450b includes a base 451b and a cover body 452b. The base 451b is a plate extending in the Y′ direction from the Y′-direction-side end of the second facing portion 423b. The cover body 452b is a plate of an arc shape integral and contiguous with the Y′-direction-side end of the base 451b. The cover body 452b partially covers the exposed shield conductor of the second cable 300b. If the second shell 400b includes the second cover 450b, the second holding plate 470a of the first shell 400a is curved so as to be wound around the cover body 452b and the exposed shield conductor of the second cable 300b as best illustrated in FIG. 2H.

Each third terminal 200c is constituted by a metal plate and held by the body 100b. As each third terminal 200c may have a similar configuration to that of a first terminal 200a, as best illustrated in FIG. 2D, it will not be described. The third terminal 200c includes a contact portion 210c, an intermediate portion 220c, and a tail 230c.

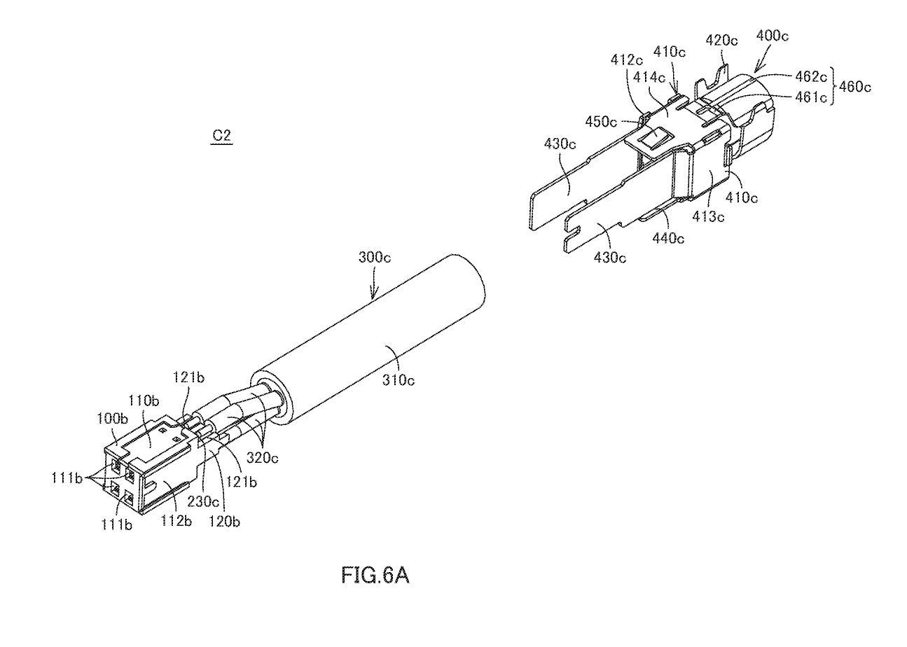

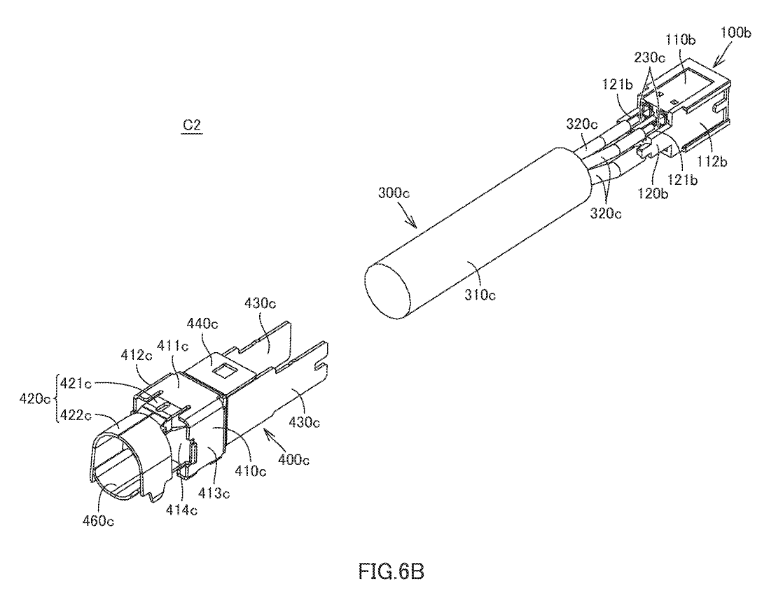

The body 100b is formed of insulation resin. As best illustrated in FIGS. 6A and 6B, the body 100b includes a main body 110b. The main body 110b is a rectangular block. The main body 110a has an outer shape conforming to the shape of the housing portion 113a2 of the body 100a. The main body 110a is housed in the housing portion 113a2 of the body 100a. The body 100b is housed, together with the body 100a, in the shell body 410b of the second shell 400b.

The main body 110b holds the at least one third terminal 200c. The main body 110b may have at least one holding hole 111b. The main body 110b may be provided with a plurality of holding holes 111b arranged in two rows in the Z-Z′ direction, at spaced intervals along the X-X′ direction. As best illustrated in FIG. 2D, each holding hole 111b extends through the main body 110b in the Y-Y′ direction. Each holding hole 111b has a shape conforming to the outer shape of the intermediate portion 220c of a third terminal 200c. Each holding hole 111b holds the intermediate portion 220c of a third terminal 200c and houses the contact portion 210c of the third terminal 200c. Each holding hole 111b communicates with an opening 113a3 of the body 100a. Also, the at least one third terminal 200c may be insert-molded in the main body 110b. In this case, the holding hole 111b is omitted.

The main body 110b further includes an end face on the X-direction side and an end face on X′-direction side. As best illustrated in FIGS. 6A and 6B, the end faces of the X- and X′-direction sides of the main body 110b may each be provided with an engaging recess 112b.

The body 100b may further include a table 120b. The table 120b extends in the Y′ direction from the Y′-direction-side end of the main body 110b. The table 120b may only be able to support the tail 230c of the at least one third terminal 200c. The table 120b may include at least one holding groove 121b. Each holding groove 121b is provided in the table 120b such as to communicate with a holding hole 111b. Each holding groove 121b houses and supports a tail 230c. As best illustrated in FIG. 2F, a plurality of holding grooves 121b may be provided in the Z-direction-side face of the table 120b, at spaced intervals along the X-X′ direction, and another plurality of holding grooves 121b may be provided in the Z′-direction-side face of the first table 120a, at spaced intervals along the X-X′ direction.

As best illustrated in FIG. 6A and FIG. 6B, the third shell 400c is formed by press-forming a single metal plate. The third shell 400c includes a shell body 410c and a third holding plate 420c. The shell body 410c is a tube extending in the Y-Y′ direction and arranged between the first inner plate 440a and the second inner plate 450a of the first shell 400a (see FIG. 2G). The shell body 410c includes a first plate 411c on the Z′-direction side, a second plate 412c on the X-direction side, a third plate 413c on the X′-direction side, and a fourth plate on the Z-direction side. The first plate 411c is arranged between the first inner plate 440a and the second inner plate 450a or between the first base 410a and the second base 420a. In FIG. 2G, the first plate 411c is arranged between the first base 410a and the second base 420a. The first plate 411c includes an X-direction-side end, an X′-direction-side end, and a Y′-direction-side end. The fourth plate 414c is arranged in abutment with the center plate 430a of the first shell 400a from the Z′-direction side or arranged to face the center plate 430a of the first shell 400a with a space therebetween in the Z-Z′ direction. In FIG. 2G, the fourth plate 414c is in abutment (in surface contact) with the center plate 430a. The fourth plate 414c may engage with the center plate 430a. The fourth plate 414c includes an X-direction-side end and an X′-direction-side end. The second plate 412c integrally interjoins the X-direction-side end of the first plate 411c and the X-direction-side end of the fourth plate 414c. The second plate 412c is arranged in abutment with the first inner plate 440a of the first shell 400a or arranged to face the first inner plate 440a of the first shell 400a with a space therebetween. In FIG. 2G, the second plate 412c is in abutment (in surface contact) with the first inner plate 440a. The second plate 412c may engage with the first inner plate 440a. The third plate 413c integrally interjoins the X′-direction-side end of the first plate 411c and the X′-direction-side end of the fourth plate 414c. The third plate 413c is arranged in abutment with the second inner plate 450a of the first shell 400a or arranged to face the second inner plate 450a of the first shell 400a with a space therebetween. In FIG. 2G, the third plate 413c is in abutment with the second inner plate 450a. The third plate 413c may engage with the second inner plate 450a. The second plate 412c may further include a Y-direction-side end, and the third plate 413c may include a Y-direction-side end.

The third holding plate 420c is provided at the first plate 411c. The third holding plate 420c is arranged between the first holding plate 460a and the second holding plate 470a of the first shell 400a (see FIG. 2H). The third holding plate 420c includes a trunk 421c and a holding plate body 422c. The trunk 421c is a plate extending in the Y′ direction from the Y′-direction-side end of the first plate 411c. The holding plate body 422c is a plate integral and contiguous with the Y′-direction-side end of the trunk 421c. In planar development state, the holding plate body 422c is larger in X-X′ direction dimension than the trunk 421c.

The third shell 400c may further include a pair of shield plates 430c (one and the other shield plates 430c). The one shield plate 430c is a plate extending in the Y direction from the Y-direction-side end of the second plate 412c. The other shield plate 430c is a plate extending in the Y direction from the Y-direction-side end of the third plate 413c. It is preferable that distal end portions (end portions on the Y-direction side) of the shield plates 430c be respectively in abutment with at least the end faces of the X- and X′-direction sides of the main body 110b of the body 100b. The distal end portions of the shield plates 430c are housed, together with the main body 110b, in the housing portion 113a2 of the body 100a. As shown in FIGS. 2E and 2F, the one shield plate 430c is arranged between the first terminal(s) 200a and the third terminal(s) 200c, and the other shield plate 430c is arranged between the second terminal(s) 200b and the third terminal(s) 200c. The distal end portions (end portions on the Y-direction side) of the shield plates 430c may be configured to respectively engage with the engaging recesses 112b of the main body 110b of the body 100b and to respectively abut the end faces of the X- and X′-direction sides of the main body 110b. In this case, the distal ends of the shield plates 430c have outer shapes conforming to the respective shapes of the engaging recesses 112b of the main body 110b of the body 100b.

The second shell 400b may further include a seventh engaging portion. The third shell 400c may further include an eighth engaging portion. One of the seventh engaging portion and the eighth engaging portion may include an engaging protrusion, and the other may have an engaging hole to engage with the engaging protrusion.

For example, as best illustrated in FIG. 4B, the first plate of the shell body 410b of the second shell 400b may include a pair of seventh engaging portions 470b. The seventh engaging portions 470b may each include an engaging protrusion of a plate-like shape, which is formed by cutting and bending a part of the first plate of the shell body 410b such that the cut part extends in the Z′ direction from the first plate. In this case, the third shell 400c includes an eighth engaging portion 440c. The eighth engaging portion 440c includes an engaging plate and an engaging hole. The engaging plate of the eighth engaging portion 440c extends in the Y direction from the Y-direction-side end of the first plate 411c of the shell body 410c. The engaging hole of the eighth engaging portion 440c is provided in the engaging plate. As shown in FIG. 3B, the engaging protrusions of the seventh engaging portions 470b are engaged with the engaging hole of the eighth engaging portion 440c from the Z-direction side.

Further, the eighth engaging portion may include, in place of the engaging hole, an engaging protrusion on the engaging plate. The seventh engaging portion may include an engaging hole in the first plate of the shell body 410b, and the engaging hole may engage with the engaging protrusion of the eighth engaging portion.

The third shell 400c may further include a ninth engaging portion. The ninth engaging portion may only engage with the center plate 430a of the first shell 400a. For example, a ninth engaging portion 450c is provided at the fourth plate 414c of the shell body 410c. The ninth engaging portion 450c includes an engaging plate and an engaging protrusion. The engaging plate of the ninth engaging portion 450c extends in the Y direction from the Y-direction-side end of the fourth plate 414c. The engaging protrusion of the ninth engaging portion 450c is a plate formed by cutting and bending a part of the engaging plate such that the cut part extends in the Z direction from the engaging plate. The engaging protrusion of the ninth engaging portion 450c engage with the Y-direction-side end of the center plate 430a of the first shell 400a.

The first shell 400a may further include a tenth engaging portion. One of the ninth engaging portion and the tenth engaging portion may include an engaging protrusion, and the other may have an engaging hole to engage with the engaging protrusion.

The third cable 300c includes an outer insulator 310c, a shield conductor (not shown), and at least one transmission wire 320c. The outer insulator 310c is a tuboid sheath. The shield conductor, tuboid braided conductive wires or a helically wound metal foil tape, is arranged inside the outer insulator 310c. The transmission wire(s) 320c is arranged inside the shield conductor. The Y-direction-side end portion of the outer insulator 310c is cut off such as to expose the Y-direction-side end portion of the shield conductor. Around the exposed shield conductor is wound the holding plate body 422c of the third holding plate 420c of the third shell 400c for electrically connection therebetween (see FIGS. 2A, 2B, 2D, 2H, 3A, and 3B). The Y-direction-side end portion of the transmission wire 320c protrudes in the Y direction from the shield conductor. The protruding portion of each transmission wire 320c (hereinafter referred to as the protruding portion) is cut off at its distal end such as to expose the core wire inside the transmission wire 320c. The protruding portion of each transmission wire 320c passes through the shell body 410c of the third shell 400c, and the core wire of each transmission wire 320a is electrically connected to the tail 230c of a third terminal 200c. For example, there may be four transmission wires 320c, the core wires of which may be connected to the respective tails 230c of four third terminals 200c. It should be noted that FIGS. 2A, 2B, 2D, 2G, and 2H show only the outline of the section of the third cable 300c. FIGS. 6A and 6B show the holding plate body 422c before being wound around the shield conductor.

The third shell 400c may further include a third cover 460c. The third cover 460c is provided at the fourth plate 414c of the shell body 410c of the third shell 400c. The third cover 460c includes a base 461c and a cover body 462c. The base 461c is a plate extending in the Y′ direction from the Y′-direction end of the fourth plate 414c. The cover body 462c is a plate of an arc shape that is integral and contiguous with the Y′-direction-side end of the base 461c. The cover body 462c partially covers the exposed shield conductor of the third cable 300c. If the third shell 400c includes the third cover 460c, the third holding plate 420c of the third shell 400c is curved so as to be wound around the cover body 462c and the exposed shield conductor of the third cable 300c.

As shown in FIG. 1A through FIG. 2H, the connector C may further include an outer case 500. The outer case 500 is formed of insulation resin. The outer case 500 includes a front portion and a rear portion. The outer case 500 further includes a first housing portion 510 and a second housing portion 520. The first housing portion 510 is a hole in the front portion of the outer case 500 and open in the Y direction. The first housing portion 510 has a shape conforming to the outer shape of the shell body 410b of the second shell 400b. The first housing portion 510 houses the shell body 410c, the shield plate 430c of the third shell 400c, the body 100a, the body 100b, the first terminal(s) 200a, the second terminal(s) 200b, and the third terminal(s) 200c. The second housing portion 520 is a hole in the rear portion of the outer case 500, and the hole communicates with the first housing portion 510 and is open in the Y′ direction. The second housing portion 520 has a shape conforming to the outer shape of the combination of the block portion 420b and the first shell 400a. The second housing portion 520 houses the block portion 420b, the first shell 400a, a part of the third shell 400c other than the shield plate 430c, a Y-direction-side end portion of the first cable 300a, a Y-direction-side end portion of the second cable 300b, and a Y-direction-side end portion of the third cable 300c.

The connector C may further include a cap 600. The cap 600 is formed of insulation resin. The cap 600 is fitted in the second housing portion 520 such as to block the second housing portion 520 of the outer case 500 from the Y′-direction side. The cap 600 is located on the Y′-direction side relative to the first shell 400a and the third shell 400c. The cap 600 is provided with three holding grooves 610. The respective holding grooves 610 partially hold the first cable 300a, the second cable 300b, and the third cable 300c.

An assembling procedure of the connector C shown in FIGS. 1A to 6B will be hereinafter described in detail. The first unit C1 and the second unit C2 will be assembled independently.

An assembling procedure of the first unit C1 will be hereinafter described in detail. The body 100a, the first terminal(s) 200a, and the second terminal(s) 200b are prepared. Each first terminal 200a is inserted into a holding hole 111a1 of the body 100a from the Y′-direction side. This results in that the intermediate portion 220a and the contact portion 210a of each first terminal 200a are housed in a holding hole 111a1 of the body 100a, and the tail 230a of each first terminal 200a is housed in a holding groove 121a of the body 100a. Each second terminals 200b is inserted into a holding hole 112a1 of the body 100a from the Y′-direction side. This results in that the intermediate portion 220b and the contact portion 210b of each second terminal 200b are housed in a holding hole 112a1 of the body 100a, and the tail 230b of the second terminal 200b is housed in a holding groove 131a of the body 100a. Thus the first terminal(s) 200a and the second terminal(s) 200b are held by the body 100a.

After that, the first cable 300a and the second cable 300b are prepared. The end portions on the Y-direction side of the first and second cables 300a and 300b have been processed as described above. The core wire of each transmission wire 320a of the first cable 300a is soldered to the tail 230a of a first terminal 200a on Z′-direction side. The core wire of each transmission wire 320b of the second cable 300b is soldered to the tail 230b of a second terminal 200b at the side of the Z′ direction respectively.

After that, the second shell 400b is prepared. The body 100b is fitted into the shell body 410b of the second shell 400b from the Y′-direction side. This results in that the body 100b, the first terminal(s) 200a, and the second terminal(s) 200b are arranged inside the shell body 410b. Also, the first cover 440b of the second shell 400b is brought into contact with the exposed shield conductor of the first cable 300a. The second cover 450b of the second shell 400b is brought into contact with the exposed shield conductor of the second cable 300b.

After that, the first shell 400a is prepared. The first shell 400a is attached to the second shell 400b from the Z′-direction side. This attachment results in the arrangements 1) to 6) as follows. 1) The protruding portion of each transmission wire 320a of the first cable 300a is arranged such as to pass through the first housing space and the first gap of the first shell 400a. The protruding portion of each transmission wire 320b of the second cable 300b is arranged such as to pass through the second housing space and the second gap of the first shell 400a. 2) The first holding plate 460a of the first shell 400a is arranged to face the exposed shield conductor of the first cable 300a. The second holding plate 470a of the first shell 400a is arranged to face the exposed shield conductor of the second cable 300b. 3) The center plate 430a, the first outer plate 480a, and the second outer plate 490a of the first shell 400a is brought into abutment with the block portion 420b of the second shell 400b from the Z′-direction side, and the block portion 420b blocks the first housing space and the second housing space of the first shell 400a from the Z-direction side. 4) The first engaging portion 441a of the first shell 400a is engaged with the second engaging portion 424b of the block portion 420b from the Z′-direction side, and the first engaging portion 451a of the first shell 400a is engaged with the second engaging portion 425b of the block portion 420b from the Z′-direction side. 5) The third engaging portions 483a and 493a of the first shell 400a are respectively engaged with the engaging holes of the fourth engaging portion 430b of the second shell 400b. 6) The engaging protrusions of the sixth engaging portion 460b of the second shell 400b are respectively engaged with the engaging holes of the fifth engaging portion 414a of the first base 410a and the fifth engaging portion 424a of the second base 420a of the first shell 400a from the Z-direction side.

After that, the first holding plate 460a of the first shell 400a is curved and wound around the first cover 440b of the second shell 400b and the exposed shield conductor of the first cable 300a. The first holding plate 460a is swaged to be fixed to the first cable 300a. The second holding plate 470a of the first shell 400a is curved and wound around the second cover 450b of the second shell 400b and the exposed shield conductor of the third cable 300c. The second holding plate 470a is swaged to be fixed to the second cable 300b. In this way, it is possible to swage the first holding plate 460a and the second holding plate 470a without being interfered by the third holding plate 420c of the third shell 400c. As described above, with the first shell 400a attached to the second shell 400b, the first unit C1 is assembled.

An assembling procedure of the second unit C2 will be hereinafter described in detail. The body 100b and the third terminal(s) 200c are prepared. Each third terminal 200c is inserted into a holding hole 111b of the body 100b from the Y′-direction side. This results in that the intermediate portion 220c and the contact portion 210c of each third terminal 200c are housed in a holding hole 111b of the body 100b, and the tail 230c of each third terminal 200c is housed in a holding groove 121c of the body 100b. In this way, the third terminal(s) 200c is held by the body 100b.

After that, the third cable 300c is prepared. The Y-direction-side end portion of the third cable 300c have been processed as described above. The core wire of each transmission wires 320c of the third cable 300c is soldered to the tail 230c of a third terminal 200c.

After that, the third shell 400c is prepared. The third shell 400c is a state in which the shell body 410c is in planar development state. The shield plate 430c on the X′-direction side of the third shell 400c is engaged with the engaging recess 112b on the X′-direction side of the body 100b. After that, the shell 400c of the third shell 400c is formed into a tubular shape. This forming results in the following arrangements 7) to 10). 7) The shield plate 430c on the X-direction side of the third shell 400c is engaged with the engaging recess 112b on the X-direction side of the body 100b. 8) The transmission wire(s) 320c of the third cable 300c is arranged to pass through the shell body 410c. 9) The third cover 460c of the third shell 400c is brought into contact with the exposed shield conductor of the third cable 300c. 10) The third holding plate 420c of the third shell 400c is arranged to face the exposed shield conductor of the third cable 300c.

After that, the third holding plate 420c of the third shell 400c is curved and wound around the third cover 460c of the third shell 400c and the exposed shield conductor of the third cable 300c. The third holding plate 420c of the third shell 400c is swaged to be fixed to the third cable 300c. As described above, the second unit C2 is assembled. In this way, it is possible to swage the third holding plate 420c without being interfered by the first holding plate 460a and the second holding plate 470a.

An attaching procedure of the second unit C2 to the first unit C1 will be hereinafter described in detail. The body 100b and the third terminal 200c of the second unit C2, and the distal ends of the pair of the shield plates 430c of the third cable 300c of the second unit C2 are fitted into the housing portion 113a2 of the body 100b of the first unit C1. This fitting results in the following arrangements 11) to 15). 11) The distal end portions of the shield plates 430c are respectively arranged between the first terminal(s) 200a and the third terminal(s) 200c and between the second terminal(s) 200b and the third terminal(s) 200c. 12) The body 100b, the third terminal(s) 200c and the distal ends of the pair of the shield plates 430c of the third cable 300c are arranged inside the shell body 410b of the second shell 400b of the first unit C1. 13) The third holding plate 420c of the third shell 400c is arranged between the first holding plate 460a and the second holding plate 470a of the first shell 400a. 14) The engaging protrusions of each seventh engaging portion 470b of the second shell 400b is engaged with an engaging hole of the eighth engaging portion 440c of the third shell 400c. 15) The ninth engaging portion 450c of the third shell 400c is engaged with the Y-direction-side end of the center plate 430a of the first shell 400a. In this way, the second unit C2 is attached to the first unit C1.

After that, the cap 600 is prepared. The first cable 300a, the second cable 300b, and the third cable 300c are held by the holding grooves 610 of the cap 600 respectively. After that, the outer case 500 is prepared. The outer case 500a is made to house the first unit C1 and the second unit C2 as combined (excluding the parts other than the Y-direction-side end portions of the first, second, and third cables 300a, 300b, and 300c). The cap 600 is fitted into the outer case 500. Thus, the connector C is assembled.

The connector C of the aspects described above have at least the following technical features. Firstly, the first shell 400a in three-dimensional state has a decreased dimension in the X-X′ direction for the following reasons. The first shell 400a in three-dimensional state is configured such that: the center plate 430a is arranged on the Z-direction side relative to the first base 410a and the second base 420a; the first inner plate 440a extends from the first end 411a of the first base 410a to the first end 431a of the center plate 430a; and the second inner plate 450a extends from the first end 421a of the second base 420a to the second end 432a of the center plate 430a. This configuration decreases the space in the X-X′ direction between the first base 410a and the second base 420a, thereby decreasing the X-X′ direction dimension of the first shell 400a in three-dimensional state, and accordingly, decreasing the X-X′ direction dimension of the connector C.

Secondly, the first shell 400a in planar development state has an increased space in the X-X′ direction between the first holding plate 460a and the second holding plate 470a. The first shell 400a in planar development state is configured such that the center plate 430a, the first inner plate 440a, the second inner plate 450a, the first base 410a and the second base 420a are aligned along the X-X′ direction. Such alignment results in that the space in the X-X′ direction between the first base 410a and the second base 420a increases by the sum of the X-X′ direction dimensions of the center plate 430a, the first inner plate 440a and the second inner plate 450a. This in turn results in increased space in the X-X′ direction between the first holding plate 460a, which is integral and contiguous with the first base 410a, and the second holding plate 470a, which is integral and contiguous with the second base 420a. Therefore, it is easy to form the first base 410a and the second base 420a when pressing a single metal plate to form the first shell 400a.

Thirdly, the existence of the second unit C2 does not result in increase in X-X′ direction dimension of the connector C for the following reason. The body 100b of the second unit C2 is housed in the housing portion 113a2 of the body 100a of the first unit C1, and the shell body 410c of the third shell 400c of the second unit C2 is arranged between the first inner plate 440a and the second inner plate 450a of the first shell 400a of the first unit C1, and the third holding plate 420c of the third shell 400c is arranged between the first holding plate 460a and the second holding plate 470a of the first shell 400a. Therefore, attaching the second unit C2 to the first unit C1 does not result in an increased X-X′ direction dimension of the connector.

Fourthly, the shield case S of the connector C has an improved strength. This is because the shell body 410c of the third shell 400c abuts the center plate 430a, the first inner plate 440a, and the second inner plate 450a of the first shell 400a from inside and also fits inside the combination of the center plate 430a, the first inner plate 440a and the second inner plate 450a (a fitting structure). Further, the first shell 400a, the second shell 400b and the third shell 400c are engaged with each other as described above. Therefore, a load due to prying of the first cable 300a, the second cable 300b, and/or the third cable 300c in the X-X′ direction will spread over the fitting structure.

Fifthly, the connector C has a decreased number of components. The first terminal 200a and the second terminal 200b are held by a single body 100a. The body 100a and the body 100b holding the third terminal(s) 200c are housed in the shell body 410b of a single second shell 400b. It is therefore possible to decrease the number of the components for the connector C, compared to a connector in which the first terminal(s) 200a, the second terminal(s) 200b, and the third terminal(s) 200c are respectively held by different bodies and the bodies are respectively housed in different shells.

Sixthly, it is possible to prevent misalignment in the X-X′ direction between the first shell 400a and the second shell 400b for the following reason. The first engaging portion 441a of the first shell 400a is engaged with the second engaging portion 424b of the second shell 400b and the first engaging portion 451a of the first shell 400a is engaged with the second engaging portion 425b of the second shell 400b, while the third engaging portion 483a and the third engaging portion 493a of the first shell 400a are respectively engaged with the engaging holes of the fourth engaging portion 430b of the second shell 400b.

It should be appreciated that the shield case and the connector described above are not limited to the embodiments described above but may be modified in any manner within the scope of the claims. The details are as follows.

The shield case of the invention may be modified in any manner as long as the shield case includes at least the first shell of any of the above aspects or a first shell as described below. The first shell of the shield case of the invention may be modified in any manner as long as the first shell includes the first base, the second base, the center plate, the first inner plate, the second plate, the first holding plate, and the second holding plate of any of the above aspects. For example, the first shell may include a plurality of shell parts adjacent to each other in the X-X′ direction. In this case, the shell parts includes two shell parts adjacent to each other. The two shell parts share the first base of any of the above aspects. The center plate of one of the shell parts and the center plate of the other shell part are arranged with a space therebetween in the X-X′ direction. The first inner plate of the one shell part extends from the X-direction-side end of the shared first base to the X′-direction-side end of the center plate of the one shell part. The first inner plate of the other shell part extends from X′-direction-side end of the shared first base to X-direction-side end of the center plate of the other shell part. Other than these features, each shell part may have the same configuration as the first shell of any of the above aspects; however, the first outer plate is omitted. It should be noted that the first shell of the shield case of the invention may be provided without the first outer plate, the second outer plate, the first engaging portion, the third engaging portion, the fifth engaging portion, and/or the tenth engaging portion.

The shield case of the invention may include at least the first shell and the block portion of any of the above aspects. In this case, the block portion is not part of the second shell, and the shell body of the second shell is omitted. Alternatively, the shield case of the invention may include at least the first shell and the shell body of the second shell of any of the above aspects. In this case, the block portion of the second shell is omitted. The shell body of the second shell of the invention may be arranged on the Y- or Y′-direction side relative to the first shell. The second shell or the block portion that is not part of the second shell of the shield case of the invention is not limited to one formed by press-forming a metal plate. For example, the second shell or the block portion that is not part of the second shell of the shield case of the invention may be constituted by a metal plate formed by casting. It should be noted that the second shell of the shield case of the invention may be provided without the second engaging portion, the fourth engaging portion, the first cover, the second cover, the sixth engaging portion, and/or the seventh engaging portion.

The third shell of the shield case of the invention may be omitted. If the third shell is omitted, it is preferable that the protruding portion(s) of the transmission wire(s) of the third cable passes through between the first inner plate and the second inner plate of the first shell of any of the above aspects. The third shell of the shield case of the invention may include the first plate and the third holding plate of the third shell of any of the above aspects. In this case, the second to the fourth plates of the shell body of the third shell are omitted. The shell body of the third shell of the shield case of the invention may include the first plate, the second plate, and the third plate of the third shell of any of the above aspects. In this case, the fourth plate of the shell body of the third shell is omitted. The third shell of the shield case of the invention is not limited to a metal plate formed by press-forming. For example, the third shell of the shield case of the invention may be constituted by a metal plate formed by casting. It should be noted that the third shell of the shield case of the invention may be provided without the shield plate, the eighth engaging portion, the ninth engaging portion, and/or the third cover. The third cover of the invention may be provided at the block portion of any of the above aspects.

The first cable of the invention may only be electrically connected to the first terminal(s) of any of the above aspects. For example, the first cable may be electrically connected to the first terminal(s) via connection means, such as a substrate, a cable(s), or a pin(s). The second cable of the invention may only be electrically connected to the second terminal(s) of any of the above aspects. For example, the second cable may be electrically connected to the second terminal(s) via connection means, such as a substrate, a cable(s), or a pin(s). The third cable of the invention may only be electrically connected to the third terminal(s) of any of the above aspects. For example, the third cable may be electrically connected to the third terminal(s) via a connection means, such as a substrate, a cable(s), or a pin(s).

The connector of the invention may be modified in any manner as long as the connector includes the first terminal(s), the second terminal(s), the shield case, the first cable, and the second cable of any of the above aspects. The connector of the invention may further include the first body to hold the first terminal(s) of any of the above aspects and the second body to hold the second terminal (s) of any of the above aspects. In this case, the second unit may be omitted. Alternatively, the connector of the invention may further include the first body to hold the first terminal(s) of any of the above aspects, the second body to hold the second terminal(s) of any of the above aspects, and the third body to hold the third terminal(s) of any of the above aspects. Alternatively, the connector of the invention may further include the first body to hold the first terminal(s) and the second terminal(s) of any of the above aspects, and the third body to hold the third terminal(s) of any of the above aspects. Alternatively, the connector of the invention may further include the first body to hold the first terminal(s), the second terminal(s), and the third terminal(s) of any of the above aspects.

The first body of any of the above aspects may be arranged on the first base of the first shell of any of the above aspects, or may be housed inside the second shell of any of the above aspects. In the former case, it is preferable to omit the shell body of the second shell.

The second body of any of the above aspects may be arranged on the second base of the first shell of any of the above aspects, or may be housed inside the second shell of any of the above aspects. In the former case, it is preferable to omit the shell body of the second shell.

The third body of any of the above aspects may be arranged between the first inner plate and the second inner plate of the first shell of any of the above aspects, or may be arranged on the first plate of the third shell of any of the above aspects, or may be housed inside the second shell of any of the above aspects. In the former two cases, it is preferable to omit the shell body of the second shell.

It is possible to omit the outer case and/or the cap of the connector of the invention.

It should be noted that the materials, the shapes, the dimensions, the numbers, the positions, etc. of the components of the shield case and the connector in the above-described embodiments and their variants are presented by way of example only and can be modified in any manner so far as the same functions can be fulfilled. The aspects and variants of the above-described embodiments can be combined in any possible manner. The first direction (including the X-X′ direction) of the invention may be defined in any manner as long as the first direction corresponds to the alignment direction of the first base and the second base of the first shell of the invention. The second direction (including the Y-Y′ direction) of the invention may be defined in any manner as long as the second direction crosses the first direction. The third direction (including the Z-Z′ direction) of the invention may be defined in any manner as long as the third direction crosses the first and second directions and is located on a different plane from the plane where the first and second directions are located.

### REFERENCE SIGNS LIST

C: connector
C1: first unit
100a: body (first body)
110a: main body
111a: first holding portion
111a1: holding hole
112a: second holding portion
112a1: holding hole
113a: joint portion
113a1: front panel
113a2: housing portion
113a3: opening
120a: first table
121a: holding groove
130a: second table
131a: holding groove
200a: first terminal
210a: contact portion
211a: arm
220a: intermediate portion
221a: first plate
222a: second plate
223a: joint plate
230a: tail
200b: second terminal
210b: contact portion
220b: intermediate portion
230b: tail
300a: first cable
310a: outer insulator
320a: transmission wire
300b: second cable
310b: outer insulator
320b: transmission wire
400a: first shell
410a: first base
411a: first end
412a: second end
413a: third end
414a: fifth engaging portion
420a: second base
421a: first end
422a: second end
423a: third end
424a: fifth engaging portion
430a: center plate
431a: first end
432a: second end
440a: first inner plate
441a: first engaging portion
450a: second inner plate
451a: first engaging portion
460a: first holding plate
461a: trunk
462a: holding plate body
470a: second holding plate
471a: trunk
472a: holding plate body
480a: first outer plate
481a: outer plate body
482a: extension plate
483a: third engaging portion
490a: second outer plate
491a: outer plate body
492a: extension plate
493a: third engaging portion
400b: second shell
410b: shell body
420b: block portion
421b: center portion
422b: first facing portion
423b: second facing portion
424b: second engaging portion
425b: second engaging portion
430b: fourth engaging portion
440b: first cover
441b: base
442b: cover body
450b: second cover
451b: base
452b: cover body
460b: sixth engaging portion
470b: seventh engaging portion
C2: second unit
100b: body (third body)
110b: main body
111b: holding hole
112b: engaging recess
120b: table
121b: holding groove
200c: third terminal
210c: contact portion
220c: intermediate portion
230c: tail
300c: third cable
310c: outer insulator
320c: transmission wire
400c: third shell
410c: shell body
411c: first plate
412c: second plate
413c: third plate
414c: fourth plate
420c: holding plate
421c: trunk
422c: holding plate body
430c: shield plate
440c: eighth engaging portion
450c: ninth engaging portion
460c: third cover
461c: base
462c: cover body
500: outer case
510: first housing portion
520: second housing portion
600: cap
610: holding groove
S: shield case

1. A shield case comprising a first shell constituted by a metal plate, the first shell comprising:
a first base of a plate-like shape, a second base of a plate-like shape, a center plate, a first inner plate, a second inner plate, a first holding plate, and a second holding plate, wherein
the first base and the second base are arranged in spaced side-by-side relation along a first direction,
the first base comprises a first end at a side of the second base and a second end at one side of a second direction, the second direction crossing the first direction;
the second base comprises a first end at a side of the first base and a second end at one side of the second direction;
the center plate is arranged on one side of a third direction relative to the first and second bases, and the center plate comprises a first end on the one side of the first direction and a second end on the other side of the first direction, the third direction crossing the first and second directions;
the first inner plate extends to the one side of the third direction, from the first end of the first base to the first end of the center plate;
the second inner plate extends to the one side of the third direction, from the first end of the second base to the second end of the center plate;
the first holding plate is integral and contiguous with the second end of the first base; and
the second holding plate is integral and contiguous with the second end of the second base.

2. The shield case according to claim 1, wherein the first shell further comprises:
a first outer plate formed at the first base and located on the one side of the first direction relative to the first inner plate with a space therebetween, and
a second outer plate formed at the second base and located on the other side of the first direction relative to the second inner plate with a space therebetween.

3. The shield case according to claim 1, further comprising a block portion having electrical conductivity, the block portion being arranged in abutment with or in spaced relation to the center plate of the first shell, the block portion comprising:
a first facing portion arranged in facing relation to and in spaced relation in the third direction to the first base, and
a second facing portion arranged in facing relation to and in spaced relation in the third direction to the second base.

4. The shield case according to claim 3, wherein:
the first shell further comprises a first engaging portion provided at at least one of the first inner plate, the second inner plate, and the center plate,
the block portion further comprises a second engaging portion, and
one of the first engaging portion and the second engaging portion comprises an engaging protrusion, and the other comprises an engaging hole to engage with the engaging protrusion.

5. The shield case according to claim 2, wherein:
the first shell further comprises a third engaging portion provided at at least one of the first outer plate and the second outer plate,
the shield case further comprises a block portion having electrical conductivity, the block portion being arranged in abutment with or in spaced relation to the center plate of the first shell,
the block portion comprises:
a first facing portion arranged in facing relation to and in spaced relation in the third direction to the first base, and
a second facing portion arranged in facing relation to and in spaced relation in the third direction to the second base, and
a fourth engaging portion provided at at least one of the first facing portion and the second facing portion, and
one of the third engaging portion and the fourth engaging portion comprises an engaging protrusion, and the other comprises an engaging hole to engage with the engaging protrusion.

6. The shield case according to claim 3, wherein:
the first shell further comprises a fifth engaging portion provided at at least one of the first base and the second base,
the shield case further comprises a second shell having electrical conductivity,
the second shell comprises the block portion, a shell body, and a sixth engaging portion provided at the shell body, and
one of the fifth engaging portion and the sixth engaging portion comprises an engaging protrusion, and the other comprises an engaging hole to engage with the engaging protrusion.

7. The shield case according to claim 1, further comprising a third shell having electrical conductivity, wherein:
the third shell comprises a first plate and a third holding plate,
the first plate of the third shell is arranged between the first base and the second base or between the first inner plate and the second inner plate and comprises an end on one side of the second direction, and
the third holding plate of the third shell is provided at the end of the first plate of the third shell and arranged between the first holding plate and the second holding plate.

8. The shield case according to claim 7, wherein:
the third shell further comprises a shell body arranged between the first inner plate and the second inner plate, and
the shell body of the third shell comprises:
a second plate in abutment with the first inner plate,
a third plate in abutment with the second inner plate, and
the first plate of the third shell to interjoin the second plate and the third plate.

9. The shield case according to claim 8, wherein:
the shell body of the third shell further comprises a fourth plate, and
the fourth plate of the third shell interjoins the second plate and the third plate and is in abutment with the center plate of the first shell.

10. The shield case according to claim 6, wherein:
the second shell further comprises a seventh engaging portion provided at the shell body of the second shell,
the shield case further comprises a third shell having electrical conductivity,
the third shell comprises:
a shell body arranged between the first inner plate and the second inner plate,
a third holding plate, and
an eighth engaging portion,
the shell body of the third shell comprises a first plate,
the first plate is arranged between the first base and the second base or between the first inner plate and the second inner plate and comprises an end on one side of the second direction,
the third holding plate of the third shell is provided at the end of the first plate of the third shell and arranged between the first holding plate and the second holding plate,
the eighth engaging portion of the third shell is provided at the shell body of the third shell, and
one of the seventh engaging portion and the eighth engaging portion comprises an engaging protrusion, and the other comprises an engaging hole to engage with the engaging protrusion.

11. A connector comprising:
a first terminal;
a second terminal;
the shield case according to claim 1;
a first cable electrically connected to the first terminal and held by the first holding plate of the first shell; and
a second cable electrically connected to the second terminal and held by the second holding plate of the first shell.

12. The connector according to claim 11, further comprising a first body to hold the first terminal and the second terminal.

13. The connector according to claim 12, wherein
the shield case further comprises a second shell having electrical conductivity, and
the second shell houses at least the first body.

14. The connector according to claim 12, wherein the first body comprises:
a first holding portion arranged on the first base of the first shell to hold the first terminal,
a second holding portion arranged on the second base of the first shell to hold the second terminal, and
a joint portion to interjoin the first holding portion and the second holding portion.

15. The connector according to claim 11, further comprising:
first body to hold the first terminal, and
a second body to hold the second terminal.

16. The connector according to claim 15, wherein
the shield case further comprises a second shell having electrical conductivity, and
the second shell houses the first body and the second body.

17. The connector according to claim 15, wherein:
the first body is arranged on the first base of the first shell, and
the second body is arranged on the second base of the first shell.

18. A connector comprising:
a first terminal;
a second terminal;
a third terminal;
the shield case according to claim 7;
a first cable electrically connected to the first terminal and held by the first holding plate of the first shell;
a second cable electrically connected to the second terminal and held by the second holding plate of the first shell; and
a third cable electrically connected to the third terminal and held by the third holding plate of the third shell.

19. The connector according to claim 18, further comprising:
a first body to hold the first terminal and the second terminal, and
a third body to hold the third terminal.

20. The connector according to claim 19, wherein:
the first body comprises:
a first holding portion to hold the first terminal,
a second holding portion to hold the second terminal, and
a joint portion to interjoin the first holding portion and the second holding portion,
the joint portion comprises a housing portion,
the third body is housed in the housing portion, and
the shield case further comprises a second shell having electrical conductivity, the second shell housing the first body and the third body.

21. The connector according to claim 19, wherein:
the first body comprises:
a first holding portion arranged on the first base of the first shell to hold the first terminal,
a second holding portion arranged on the second base of the first shell to hold the second terminal, and
joint portion to interjoin the first holding portion and the second holding portion, and
the third body is arranged on the first plate of the third shell.
